(19) United States
(12) Patent Application Publication
(10) Pub. No.: US 2004/0047952 A1
(43) Pub. Date: Mar. 11, 2004

(54) Modified atmosphere packages and methods for making the same

(76) Inventors: Marcus C. Merriman, Fairport, NY (US); Gary R. DelDuca, Canandaigua, NY (US); Vinod K. Luthra, Pittsford, NY (US); Stephen L. Goulette, Newark, NY (US)

Correspondence Address: JENKENS & GILCHRIST, P.C., 225 WEST WASHINGTON, SUITE 2600, CHICAGO, IL, 60606, US

(21) Appl. No.: 10/424,460

(22) Filed: Apr. 25, 2003

Related U.S. Application Data
(63) Continuation of application No. 09/965,426, filed on Sep. 27, 2001.
Application No. 09/965,426 is a continuation of application No. 09/915,150, filed on Jul. 25, 2001.

(51) Int. Cl. A23B 4/00

(52) U.S. Cl. 426/124

(57) ABSTRACT

A method of manufacturing a modified atmosphere package comprises supplying a first package including a non-barrier portion substantially permeable to oxygen. A retail cut of raw meat is placed within the first package and the first package is sealed. A second package substantially impermeable to oxygen is supplied. The first package is covered with the second package without sealing the second package so as to create a pocket between the first and second packages. A mixture of gases is supplied into the pocket. The gas mixture comprises from about 0.1 to about 0.8 vol. % carbon monoxide and at least one other gas to form a low oxygen environment so as to form carboxymyoglobin on a surface of the raw meat. The oxygen is removed from the pocket so as to sufficiently reduce an oxygen level therein so as to inhibit or prevent the formation of metmyoglobin on the surface of the raw meat. The second package is sealed.

### FIELD OF THE INVENTION

The present invention relates generally to modified atmosphere packages and methods for making the same for storing food. More particularly, the invention relates to modified atmospheric packages and methods for making the same for extending the shelf life of raw meats or other food.

### BACKGROUND OF THE INVENTION

Containers have long been employed to store and transfer perishable food prior to presenting the food at a market where it will be purchased by the consumer. After perishable foods, such as meats, fruits, and vegetables, are harvested, they are placed into containers to preserve those foods for as long as possible. Maximizing the time in which the food remains preserved in the containers increases the profitability of all entities in the chain of distribution by minimizing the amount of spoilage.

The environment around which the food is preserved is a critical factor in the preservation process. Not only is maintaining an adequate temperature important, but the molecular and chemical content of the gases surrounding the food is significant as well. By providing an appropriate gas content to the environment surrounding the food, the food can be better preserved when maintained at the proper temperature or even when it is exposed to variations in temperature. This gives the food producer some assurance that after the food leaves his or her control, the food will be in an acceptable condition when it reaches the consumer.

Modified atmosphere packaging systems for one type of food, raw meats, exposes these raw meats to either extremely high levels or extremely low levels of oxygen (O₂). Packaging systems which provide extremely low levels of oxygen are generally preferable because it is well known that the fresh quality of meat can be preserved longer under anaerobic conditions than under aerobic conditions. Maintaining low levels of oxygen minimizes the growth and multiplication of aerobic bacteria. An example of a modified atmosphere environment is a mixture of gases consisting of about 30 percent carbon dioxide (CO₂) and 70 percent nitrogen (N₂). All low oxygen systems preferably provide an atmosphere for the raw meat of less than 500 ppm oxygen quickly so as to prevent or inhibit excessive metmyoglobin (brown) formation or full “bloom” to oxymyoglobin (red) following storage will not be possible.

The meat using this low oxygen system takes on a less desirable purple-red color which few consumers would associate with freshness. The deoxymyoglobin (purple-red color) is generally unacceptable to most consumers. This purple-red color, however, quickly blooms to a bright red color generally associated with freshness when the package is opened to oxygenate the fresh meat by exposure to air. The package is typically opened immediately prior to display of the fresh meat to consumers so as to induce blooming of the meat just prior to display to the consumers.

The blooming of fresh meat to a bright red color typically produces good results under existing low oxygen systems except under two different conditions. The first condition occurs when the fresh meat has been in a modified atmosphere environment for less than about five to six days. The second condition that may result in inconsistent blooming occurs when using pigment sensitive meat (unstable muscle) such as from the round bone (rear quarter) or the tenderloin. Meat off of the round bone is also referred to as top and bottom rounds.

Under the first condition, a time period, often referred to as a “seasoning” period, limits the meat's ability to fully bloom until all the oxygen has been consumed by, for example, an oxygen scavenger. The oxygen scavenger will rapidly consume the residual oxygen in the atmosphere, but residual oxygen from the meat and/or the tray still exists. A tray, such as a polystyrene foam tray, has a substantial amount of oxygen contained in its cellular structure. The time period to diffuse the oxygen contained in the cellular structure of a foam tray can be as long as about 5 to about 6 days. Thus, the seasoning period can be at least 6 days for meat stored on a foam tray. If a foam tray is not used, the “seasoning” period can be reduced to one or two days. Seasoning periods are not desired by the retailers or packers (especially with commonly used foam trays) because of the need to store and maintain the meat-filled packages for an extended duration before being opened for retail sale. Therefore, it would be desirable to reduce or eliminate the seasoning period.

As discussed above, the second condition involves pigment sensitive meat such as off the round bone (top and bottom rounds). The meat off the round bone is extremely pigment sensitive and comprises a large portion of the animal. This meat is often unstable in its color as a result of its pigment sensitivity, which makes a uniform bloom unpredictable. The round bone cuts tend to convert to metmyoglobin (brown) far more rapidly than other cuts of meat. This is exacerbated in low oxygen systems because metmyoglobin is rapidly converted by oxidation reactions of the myoglobin pigments at oxygen levels of from about 500 ppm to about 2 vol. %. Therefore, it would be desirable to obtain consistent blooming with cuts off pigment sensitive meats such as the round bone.

A need therefore exists for a modified atmosphere package and a method of making a modified atmosphere package which overcomes the aforementioned shortcomings associated with existing packages.

### SUMMARY OF THE INVENTION

According to one method of the present invention, a modified atmosphere package is manufactured that comprises supplying a first package including a non-barrier portion substantially permeable to oxygen. A retail cut of raw meat is placed within the first package and the first package is sealed. A second package substantially impermeable to oxygen is supplied. The first package is covered with the second package without sealing the second package so as to create a pocket between the first and second packages. A mixture of gases is supplied into the pocket. The gas mixture comprises from about 0.1 to about 0.8 vol. % carbon monoxide and at least one other gas to form a low oxygen environment so as to form carboxymyoglobin on a surface of the raw meat. The oxygen is removed from the pocket so as to sufficiently reduce an oxygen level therein so as to inhibit or prevent the formation of metmyoglobin on the surface of the raw meat. The second package is sealed. In another embodiment, the gas mixture may be supplied so as to substantially convert the oxymyoglobin directly to carboxymyoglobin on a surface of the raw meat.

According to another method of the present invention, a modified atmosphere package is manufactured that comprises supplying a package, a first layer having at least a portion being substantially permeable to oxygen and a second layer being substantially impermeable to oxygen. A retail cut of raw meat is placed within the package. A mixture of gases is supplied within the package. The gas mixture comprises from about 0.1 to about 0.8 vol. % carbon monoxide and at least one other gas to form a low oxygen environment so as to form carboxymyoglobin on a surface of the raw meat. The oxygen is removed within the package so as to sufficiently reduce an oxygen level therein so as to inhibit or prevent the formation of metmyoglobin on the surface of the raw meat. The first layer is sealed to the package. The second layer is sealed to at least one of the package and the first layer.

According to one embodiment of the present invention, a modified atmosphere package comprises a first and a second package. The first package comprises a non-barrier portion substantially permeable to oxygen. The first package is configured and sized to fully enclose a retail cut of raw meat. The second package is substantially impermeable to oxygen. The second package is adapted to cover the first package so as to create a pocket between the first and second packages. The pocket has a mixture of gases comprising from about 0.1 to about 0.8 vol. % carbon monoxide and at least one other gas to form a low oxygen environment so as to form carboxymyoglobin on a surface of the raw meat.

According to another embodiment of the present invention, a modified atmosphere package comprises first and second compartments separated by a partition member. The partition member includes a non-barrier portion substantially permeable to oxygen. The first and second compartments are encompassed by an outer wall substantially impermeable to oxygen. The second compartment is configured and sized to fully enclose a retail cut of raw meat. The first compartment contains a mixture of gases. The gas mixture comprises from about 0.1 to about 0.8 vol. % carbon monoxide and at least one other gas to form a low oxygen environment so as to form carboxymyoglobin on a surface of the meat.

According to a further embodiment of the present invention, a modified atmosphere package comprising a package, a first layer and a second layer. The package is configured and sized to fully enclose a retail cut of raw meat. The package has a mixture of gases comprising from about 0.1 to about 0.8 vol. % carbon monoxide and at least one other gas to form a low oxygen environment so as to form carboxymyoglobin on a surface of the raw meat. The first layer has at least a portion being substantially permeable to oxygen and sealed to the package. The second layer is substantially impermeable to oxygen and sealed to at least one of the package and the first layer.

The above summary of the present invention is not intended to represent each embodiment, or every aspect of the present invention. This is the purpose of the figures and detailed description which follow.

### BRIEF DESCRIPTION OF THE DRAWINGS

Other objects and advantages of the invention will become apparent upon reading the following detailed description and upon reference to the drawings in which:

FIG. 1 is an isometric view of a modified atmosphere package according to one embodiment of the present invention;

FIG. 2 is a section view taken generally along line 2-2 in FIG. 1;

FIG. 3 is an enlarged view taken generally along circled portion 3 in FIG. 2;

FIG. 4 is a diagrammatic side view of a system for making the modified atmosphere package in FIG. 1;

FIG. 5 is an isometric view of an apparatus for evacuating and/or flushing the modified atmosphere package in FIG. 1;

FIGS. 6a-d are cross-sectional views of the apparatus in FIG. 5 showing a method of operation thereof;

FIG. 7 is an isometric view of a modified atmosphere package akin to that shown in FIG. 1 except that the modified atmosphere package includes a plurality of meat-filled inner packages;

FIG. 8 is a cross-sectional view of a modified atmosphere package according to another embodiment of the present invention;

FIGS. 9a, b are cross-sectional views of modified atmosphere packages according to further embodiments of the present invention;

FIGS. 10a,b are graphs of visual color deterioration of ground beef during display following storage;

FIGS. 11a,b are graphs of visual color deterioration of strip loin during display following storage;

FIGS. 12a,b are graphs of visual color deterioration of inside round (inside portion) during display following storage;

FIGS. 13a,b are graphs of visual color deterioration of inside round (outside portion) during display following storage;

FIGS. 14a,b are graphs of visual color deterioration of tenderloin during display following storage;

FIGS. 15a,b are graphs of a* values (redness) deterioration of ground beef during display following storage;

FIGS. 16a,b are graphs of a* values (redness) deterioration of strip loin during display following storage;

FIGS. 17a,b are graphs of a* values (redness) deterioration of inside round (inside portion) during display following storage;

FIGS. 18a,b are graphs of a* values (redness) deterioration of inside round (outside portion) during display following storage;

FIGS. 19a,b are graphs of a* values (redness) deterioration of tenderloin during display following storage;

FIGS. 20a,b are graphs of total aerobic plate counts (APC) of ground beef during display following storage;

FIGS. 21a,b are graphs of total aerobic plate counts (APC) of strip loin during display following storage;

FIGS. 22a,b are graphs of total aerobic plate counts (APC) of inside round during display following storage;

FIGS. 23a,b are graphs of total aerobic plate counts (APC) of tenderloin during display following storage;

FIGS. 24a,b are graphs of lactic acid bacteria (LAB) of ground beef during display following storage;

FIGS. 25a,b are graphs of lactic acid bacteria (LAB) of strip loin during display following storage;

FIGS. 26a,b are graphs of lactic acid bacteria (LAB) of inside round during display following storage;

FIGS. 27a,b are graphs of lactic acid bacteria (LAB) of tenderloin during display following storage;

FIG. 28 is a graph of aerobic plate count vs. visual color; and

FIG. 29 is a graph of lactic acid bacteria count vs. visual color.

While the invention is susceptible to various modifications and alternative forms, certain specific embodiments thereof have been shown by way of example in the drawings and will be described in detail. It should be understood, however, that the intention is not to limit the invention to the particular forms described. On the contrary, the intention is to cover all modifications, equivalents, and alternatives falling within the spirit and scope of the invention as defined by the appended claims.

### DESCRIPTION OF ILLUSTRATIVE EMBODIMENTS

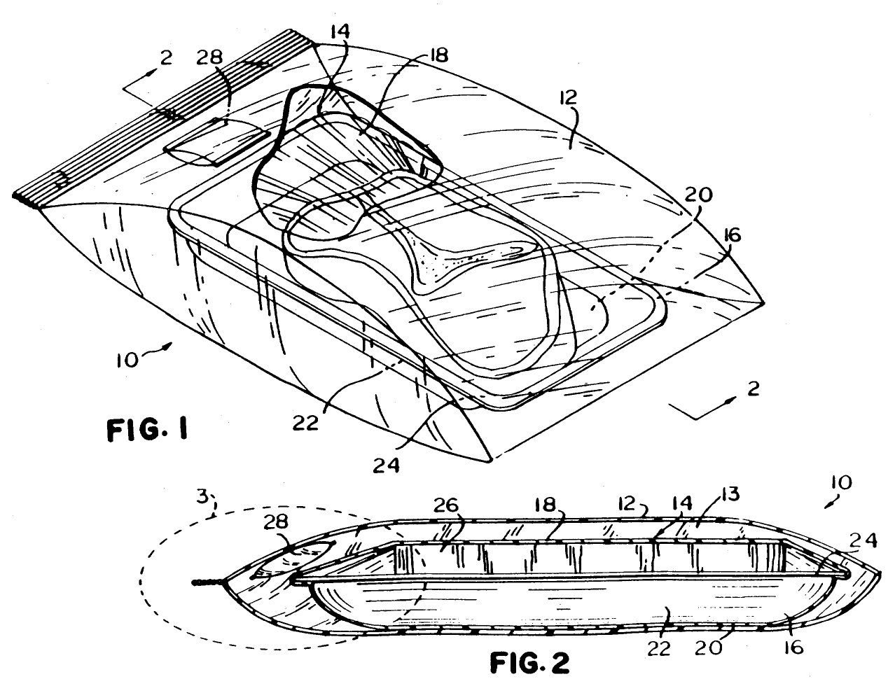

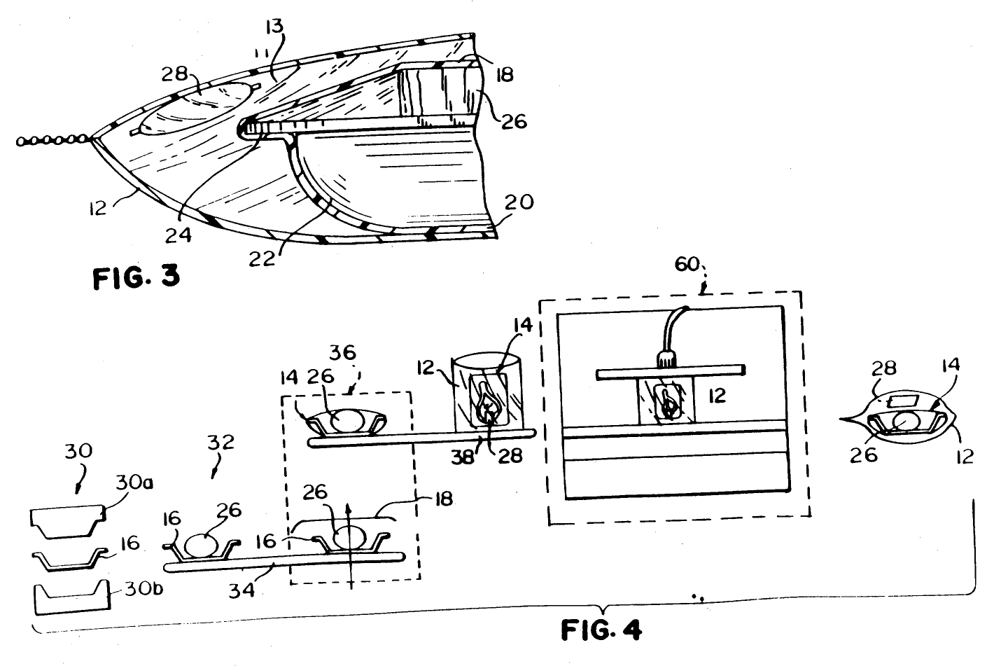

Turning now to the drawings, FIGS. 1-3 depict a modified atmosphere package 10 including a master outer package 12 and an inner package 14 according to one embodiment. The term “package” as used herein shall be defined as any means for holding raw meat, including a container, carton, casing, parcel, holder, tray, flat, bag, film envelope, etc. At least a portion of the inner package 14 is permeable to oxygen. The inner package 14 includes a conventional semi-rigid plastic tray 16 thermoformed from a sheet of polymeric material which is substantially permeable to oxygen.

Exemplary polymers which may be used to form the non-barrier tray 16 include polystyrene foam, cellulose pulp, polyethylene, polypropylene, etc. In a preferred embodiment, the polymeric sheet used to form the tray 16 is substantially composed of polystyrene foam and has a thickness ranging from about 100 to about 300 mils. The use of a polystyrene foam tray 16 is desirable because it has a high consumer acceptance.

The inner package 14 further includes a film wrapping or cover 18 comprised of a polymeric material, such as a polyolefin or polyvinyl chloride (PVC), which is substantially permeable to oxygen. The material used to form the cover 18 preferably contains additives which allow the material to cling to itself, has a thickness ranging from about 0.5 mil to about 1.5 mils, and has a rate of oxygen permeability greater than about 1000 cubic centimeters per 100 square inches in 24 hours.

The cover 18 preferably has a rate of oxygen permeability greater than about 7000 cubic centimeters per 100 square inches in 24 hours and, most preferably, the material has a rate of oxygen permeability greater than about 10,000 cubic centimeters per 100 square inches in 24 hours. To help attain this high rate of permeability, small holes may be pierced into the material. Other techniques for increasing the oxygen permeability of the inner package 14 may be used. Such techniques are disclosed in U. S. Pat. No. 6,054,153 which is incorporated herein by reference in its entirety. One preferred stretch film is Resinite™ meat film commercially available from Borden Packaging and Industrial Products of North Andover, Mass.

The tray 16 is generally rectangular in configuration and includes a bottom wall 20, a continuous side wall 22, and a continuous rim or flange 24. The continuous side wall 22 encompasses the bottom wall 20 and extends upwardly and outwardly from the bottom wall 20. The continuous rim 24 encompasses an upper edge of the continuous side wall 22 and projects generally laterally outwardly therefrom. It is contemplated that the tray 16 may be of a different shape than depicted in FIGS. 1-3. A food item such as a retail cut of raw meat 26 is located in a rectangular compartment defined by the bottom wall 20 and continuous side wall 22. The raw meat may be any animal protein, including beef, pork, veal, lamb, chicken, turkey, venison, fish, etc.

The tray 16 is manually or automatically wrapped with the cover 18. The cover 18 is wrapped over the retail cut of raw meat 26 and about both the side wall 22 and bottom wall 20 of the tray 16. The free ends of the cover 18 are overlapped along the underside of the bottom wall 20 of the tray 16, and, due to the cling characteristic inherent in the cover 18, these overlapping free ends cling to one another to hold the cover 18 in place. If desired, the overwrapped tray 16, i.e., the inner package 14, may be run over a hot plate to thermally fuse the free ends of the cover 18 to one another and thereby prevent or inhibit these free ends from potentially unraveling.

The master outer package 12 of FIGS. 1-3 is preferably a flexible polymeric bag composed of a single or multilayer plastics material which is substantially impermeable to oxygen. The package 12 may, for example, include a multilayer coextruded film containing ethylene vinyl chloride (EVOH), or include an oriented polypropylene (OPP) core coated with an oxygen barrier coating such as polyvinylidene chloride (PVDC) and further laminated with a layer of sealant material such as polyethylene to facilitate heat sealing. In a preferred embodiment, the package 12 is composed of a coextruded barrier film commercially available as product No. 325C44-EX861B from PrintPack, Inc. of Atlanta, Ga. The coextruded barrier film has a thickness ranging from about 2 mils to about 6 mils, and has a rate of oxygen permeability less than about 0.1 cubic centimeters per 100 square inches in 24 hours.

Prior to sealing the package 12, the inner package 14 is placed within the package 12 without sealing the package 12 so as to create a pocket 13 between the inner and outer packages 14 and 12. An oxygen scavenger/absorber 28, if used, may then be placed in the package 12 external to the sealed inner package 14. The oxygen scavenger 28 may be activated with an oxygen uptake accelerator to increase the rate at which the oxygen is absorbed. The oxygen uptake accelerator is preferably water or aqueous solutions of acetic acid, citric acid, sodium chloride, calcium chloride, magnesium chloride, copper or combinations thereof. The non-barrier portion of the inner package 14 allows any oxygen within the inner package 14 to flow into the pocket 13 for absorption by the oxygen scavenger 28.

Further information concerning the oxygen scavenger 28, the oxygen uptake to accelerator, and the means for introducing the oxygen uptake accelerator to the oxygen scavenger 28 may be obtained from U.S. Pat. No. 5,928,560 which is incorporated herein by reference in its entirety. In the drawings, the oxygen scavenger. 28 is illustrated as a packet or label which is inserted into the package 12 prior to sealing the package 12. Alternatively, oxygen scavenging material may be added to the polymer or polymers used to form the package 12 so that the oxygen scavenging material is integrated into the outer package 12 itself.

The oxygen level in the pocket 13 is reduced to a first level greater than zero percent. This reduction in the oxygen level may be accomplished using one or more techniques, including but not limited to evacuation, gas flushing, and oxygen scavenging. In a preferred embodiment, the package 12 is subjected to evacuation and gas flushing cycles to initially reduce the oxygen level in the pocket 13, prior to any equilibration, to less than about 0.1 volume percent or 1,000 ppm. Taking into account any oxygen disposed within the inner package 14, i.e., oxygen disposed within the meat 26 itself, the wall of the tray 16, and the free space beneath the stretch film 18, the oxygen level in the pocket 13 of no less than about 0.1 percent corresponds to an “equilibrium” oxygen level in the entire package 10 of no less than about one to two percent.

During the gas flushing process, an appropriate mixture of gases is introduced into the pocket 13 to create a modified atmosphere therein suitable for suppressing the growth of aerobic bacteria and protecting the myoglobin pigments. The gases used in the modified atmosphere packaging of the present invention comprise from about 0.1 vol. % to about 0.8 vol. % carbon monoxide in a low oxygen environment so as to form carboxymyoglobin on a surface of the raw meat 26. The gases used in the modified atmosphere packaging of the present invention preferably include from about 0.1 to about 0.6 vol. % carbon monoxide in a low oxygen environment and most preferably from about 0.3 to about 0.5 vol. % carbon monoxide in a low oxygen environment.

Examples of low oxygen environments include, but are not limited, to about 30 vol. % carbon dioxide and about 70 vol. % nitrogen or about 100 vol. % carbon dioxide. It is contemplated that other combinations of carbon dioxide and nitrogen may be used. For example, the low oxygen environment may include from about 40 to about 80 vol. % nitrogen and from about 20 to about 60 vol. % carbon dioxide. Alternatively, the low oxygen environment may be from about 0.1 vol. % to about 0.8 vol. % carbon monoxide with the remainder carbon dioxide. The package 12 is then sealed. The modified atmospheric packaging is preferably in a low oxygen environment during distribution and storage.

The modified atmosphere packaging of the present invention is believed to protect the pigment myoglobin on or near the surface of the meat during the oxygen reduction phase, allowing the meat to have an acceptable display color (i.e., a full bloom) when removed from the mixture of gases. While not being bound by theory, it is believed that the low level of carbon monoxide in the gas mixture forms carboxymyoglobin (red) and protects the myoglobin from reaching the metmyoglobin (brown) or deoxymyoglobin (purple-red) state during the storage period. Before converting to carboxymyoglobin, a surface of the meat may be at least partially oxygenated (oxymyoglobin). By converting to carboxymyoglobin on at least the surface of the meat, the myoglobin is protected during the oxygen reduction period when it is vulnerable to the formation of metmyoglobin. This protection is especially important from about 2 vol. % to about 500 or 1000 ppm oxygen when metmyoglobin forms rapidly. The myoglobin pigment of the meat is also protected by the mixture of gases used in the present invention even when the meat is stored in a foam tray that slowly diffuses oxygen.

The modified atmosphere packaging of the present invention allows the meat to be removed the day following packaging and, thus, eliminates the seasoning period associated with low oxygen packaging. The modified atmosphere packaging enables a storage period of from 1 to about 30 days prior to retail display. This allows the meat to be displayed for retail sale much sooner than in existing low oxygen packaging systems. Additionally, the gas mixture used in the modified atmosphere packaging of the present invention, after removal, allows the carboxymyoglobin to convert to oxymyoglobin and then to metmyoglobin (brown) in a natural time period. Since the package is opened (at least substantially permeable to oxygen) before retailing, the carbon monoxide level is lost to the atmosphere, thus allowing the conversion of carboxymyoglobin to oxymyoglobin by using the oxygen from the air. The meat, following storage in the gas mixture of the present invention, surprisingly allows the meat pigment to convert to metmyoglobin in a similar fashion as fresh, raw meat in a retail environment. In other words, the meat pigment tends to turn brown in a natural time period. Thus, most importantly the gas mixture of the present invention does not “fix” the color of the meat pigment to red as with higher levels of carbon monoxide. Currently, governmental regulations in the United States do not allow the use of carbon monoxide. It is generally held in the industry that carbon monoxide “fixes” the color of the meat pigment to red.

According to one embodiment, after the package 12 is sealed, the oxygen scavenger 28, if used, reduces the oxygen level throughout the package 10, including the pocket 13 and the inner package 14, to approximately zero percent in a time period of less than about 24 hours. The oxygen scavenger accelerator, if used, insures that the oxygen scavenger 28 has the aggressiveness required to rapidly move the oxygen level in the package 10 and around the meat through the pigment sensitive oxygen range of about 500 or 1000 ppm to 2 vol. %. It is preferred that the technique is fast enough to avoid the conversion of carboxymyoglobin to metmyoglobin. The oxygen scavenger 28 absorbs any residual oxygen in the pocket 13 and the inner package 14 and any oxygen that might seep into the package 10 from the ambient environment. The oxygen level of the pocket 13 is generally less than about 1,000 ppm oxygen and preferably less than about 500 ppm oxygen.

The retail cut of raw meat 26 within the modified atmosphere package 10 takes on a red color (carboxymyoglobin) when the oxygen is removed from the interior of the package 10. The gas mixture is preferably supplied to the pocket 13 such that the oxymyoglobin substantially converts directly to carboxymyoglobin. The pigment myoglobin on a surface of the meat 26 is typically partially or totally oxygenated (oxymyoglobin). It is contemplated, however, that the myoglobin may convert to deoxymyoglobin before the gas mixture is supplied to the pocket 13 so as to allow the deoxymyoglobin to convert directly to carboxymyoglobin. The meat-filled modified atmosphere package 10 may now be stored in a refrigeration unit for several weeks prior to being offered for sale at a grocery store. A short time (e.g., less than one hour) prior to being displayed at the grocery store, the inner package 14 is removed from the package 12 to allow oxygen from the ambient environment to permeate the non-barrier tray 16 and non-barrier cover 18. The carboxymyoglobin of the raw meat 26 changes or “blooms” to oxymyoglobin when the raw meat 26 is oxygenated by exposure to air.

The gas mixture used in the modified atmosphere packaging of the present invention eliminates the seasoning period before removing the inner package 14 and, thus, enables the retailer to display the meat sooner for sale. Thus, it reduces holding time and costs associated with the storage of the packaged meats. The gas mixture used in the modified atmosphere packaging of the present invention also enables the pigment sensitive, such as meat off the round bone (top and bottom rounds), to have improved blooming, and more acceptable display color and uniformity.

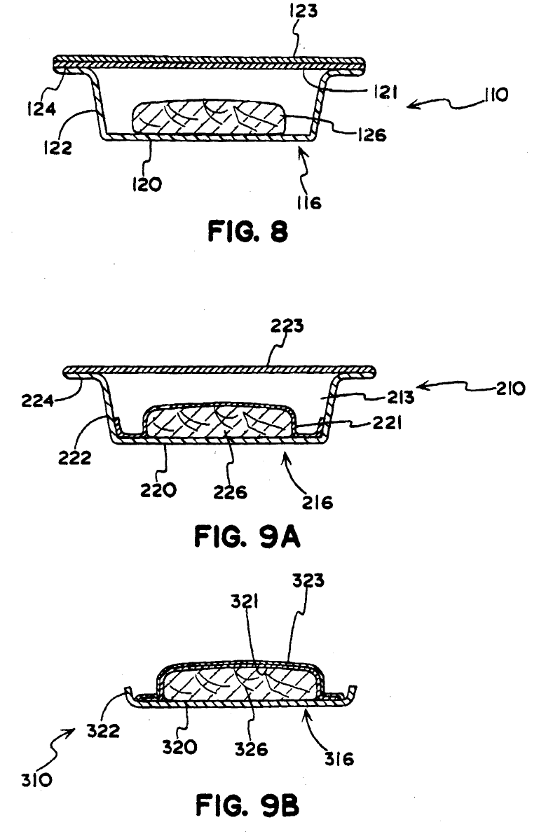

Referring to FIG. 8, modified atmosphere packaging 110 is shown according to another embodiment of the present invention. The packaging 110 includes a tray 116, a first layer 121 and a second layer 123. The packaging 110 uses the same gas mixture as described above with respect to the modified atmosphere packaging 10.

The tray 116 is generally rectangular in configuration and includes a bottom wall 120, a continuous side wall 122, and a continuous rim or flange 124. The continuous side wall 122 encompasses the bottom wall 120 and extends upwardly and outwardly from the bottom wall 120. The continuous rim 124 encompasses an upper edge of the continuous side wall 122 and projects generally laterally outwardly therefrom. It is contemplated that the continuous rim 124 may project laterally inwardly from the continuous side wall 122. It is contemplated that the tray 116 may be of a different shape than depicted in FIG. 8. A food item such as a retail cut of raw meat 126 is located in a rectangular compartment defined by the bottom wall 120 and the continuous side wall 122. The raw meat may be any animal protein, including beef, pork, veal, lamb, chicken, turkey, venison, fish, etc.

The first layer 121 has at least a portion being substantially permeable to oxygen. The first layer 121 of FIG. 8 is sealed to the tray 116. The first layer 121 comprises polymeric materials such as polyolefins and polyvinyl chloride (PVC). The first layer 121 may be a perforated layer.

The second layer 123 is substantially impermeable to oxygen. The second layer 123 is sealed to the first layer 121 in FIG. 8. The second layer 123 is adapted to be peelable from the first layer 121. It is contemplated, however, that the second layer may be sealed to the tray such as shown, for example, in FIG. 9. The second layer 123 may be made from polymeric materials such as ethylene vinyl alcohol (EVOH) and/or polyvinlidene chloride (PVDC). It is contemplated that the second layer 123 may be made of metallized films, such as a polyethylene terephthalate (PET) metallized film.

Referring to FIG. 9a, modified atmosphere packaging 210 is shown according to a further embodiment of the present invention. The packaging 210 is similar to that described above with respect to the packaging 110. The packaging 210 includes a tray 216, a first layer 221 and a second layer 223. The tray 216 includes a bottom wall 220, a continuous side wall 222 and a continuous rim or flange 224. The first layer 221 and the second layer 223 are separated from each other by a pocket 213. The pocket 213 contains the same mixture of gases as described above in the pocket 113. The first layer 221 and the second layer 223 may be made from the same materials as described above in the first layer 121 and the second layer 123, respectively. The first layer 221 is sealed to the tray 216 and surrounds a piece of raw meat 226. By illustration, such an embodiment may be similar to a blister pack.

Referring to FIG. 9b, a modified atmosphere packaging 310 is depicted according to a further embodiment of the present invention. The packaging 310 includes a first layer 321, a second layer 323, and a tray 316. The tray 316 includes a bottom wall 320 and a continuous side wall 322 and has a piece of meat 326. The layers 321 and 323 may be made from the same materials as described above in the layers 121 and 123, respectively. The mixture of gases used in the packaging 310 is the same as described above.

FIG. 4 illustrates a modified atmosphere packaging system according to one embodiment that is used to produce the modified atmosphere package 10 in FIGS. 1-3. The packaging system integrates several disparate and commercially available technologies to provide a modified atmosphere for retail cuts of raw meat. The basic operations performed by the packaging system are described below in connection with FIG. 4.

The packaging process begins at a thermoforming station 30 where the tray 16 is thermoformed in conventional fashion from a sheet of polystyrene or other non-barrier polymer using conventional thermoforming equipment. The thermoforming equipment typically includes a male die member 30a and a female die cavity 30b. As is well known in the thermoforming art, the tray 16 is thermoformed by inserting the male die member 30a into the female die cavity 30b with the polymeric sheet disposed therebetween.

The thermoformed tray 16 proceeds to a goods loading station 32 where the tray 16 is filled with a food product such as the retail cut of raw meat 26. The meat-filled tray 16 is then manually carried or transported on a conveyor 34 to a conventional stretch wrapping station 36 where the stretch film 18 is wrapped about the tray 16 to enclose the retail cut of meat 26 therein. The overwrapped tray 16 forms the inner package 14. The stretch wrapping station 36 may be implemented with a compact stretch semi-automatic wrapper commercially available from Hobart Corporation of Troy, Ohio. The inner package 14 may be transported- to the location of the package 12 by a conveyor 38.

Next, the sealed inner package 14 and the oxygen scavenger 28, if used, are inserted into a package 12. As shown in FIG. 7, the package 12 may be sized to accommodate multiple meat-filled inner packages 14 instead of a single inner package 14. Prior to sealing the package 12, the oxygen scavenger 28, if used, may be activated with the oxygen scavenger accelerator and then placed in the master bag external to the sealed inner package 14. Although the oxygen scavenger 28 is depicted in the drawings as a packet or label inserted into the package 12, an oxygen scavenger may alternatively be integrated into the polymers used to form the package 12. One oxygen scavenger is a FreshPax™ oxygen absorbing packet commercially available from MultiSorb Technologies, Inc. (formerly Multiform Desiccants Inc.) of Buffalo, N.Y.

Next, the oxygen level in the pocket 13 (FIG. 2) between the inner and outer packages 14 and 12 is reduced to the first level of no less than about 0.1 volume percent using one or more techniques, including but not limited to evacuation, gas flushing, and oxygen scavenging. As stated above, taking into account any oxygen disposed within the inner package 14, i.e., oxygen disposed within the meat 26 itself, the wall of the tray 16, and the free space beneath the stretch film 18, this oxygen level in the pocket 13 of no less than about 0.1 percent corresponds to an “equilibrium” oxygen level in the entire package 10 of no less than about one to two percent. In a preferred embodiment, the package 12 and the inner package 14 contained therein are conveyed to a vacuum and gas flushing machine 60 that may be implemented with a Corr-vac® machine commercially available from M-Tek Incorporated of Elgin, Ill.

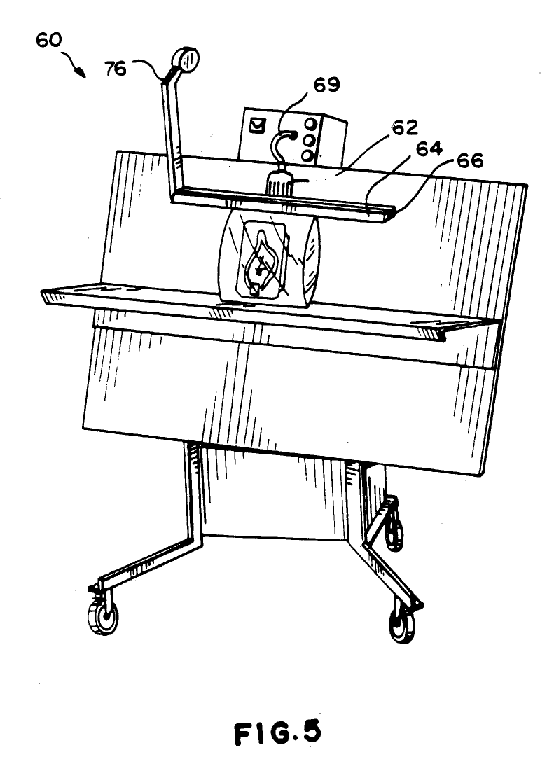

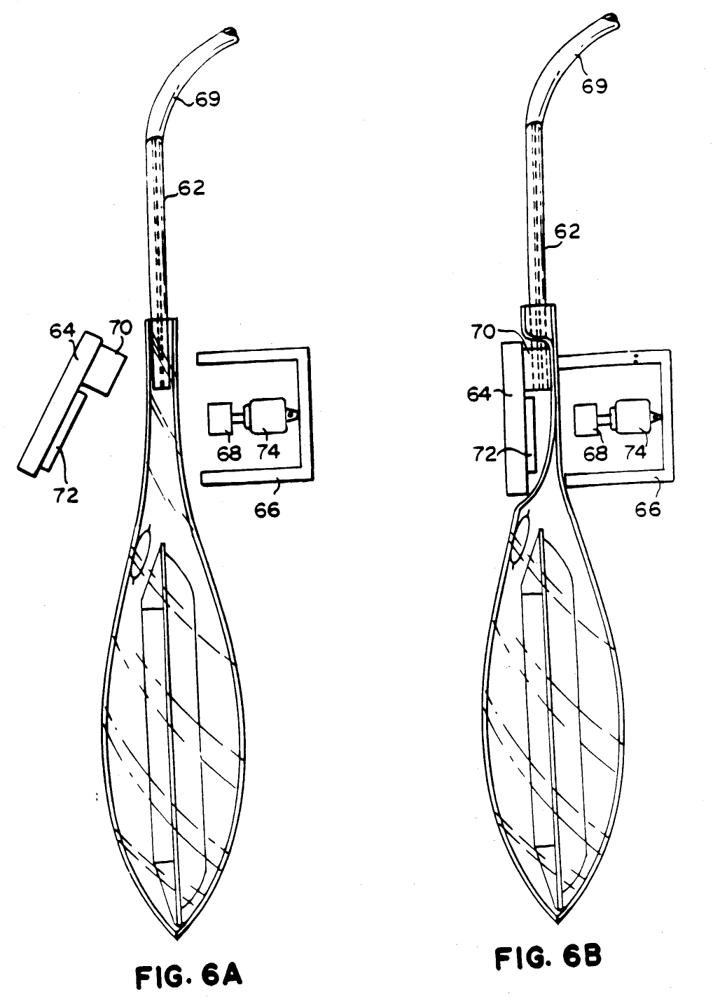

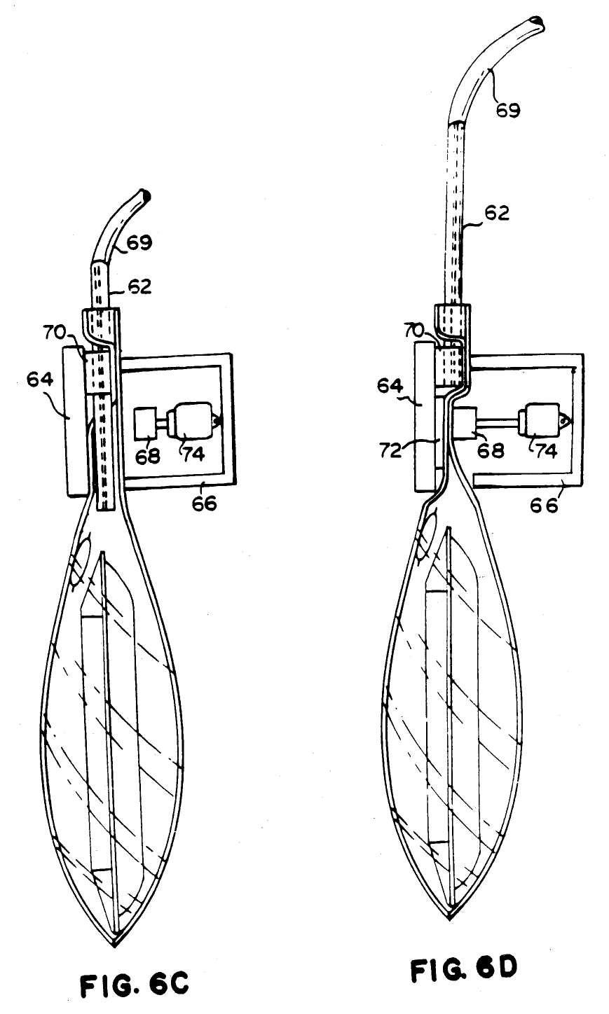

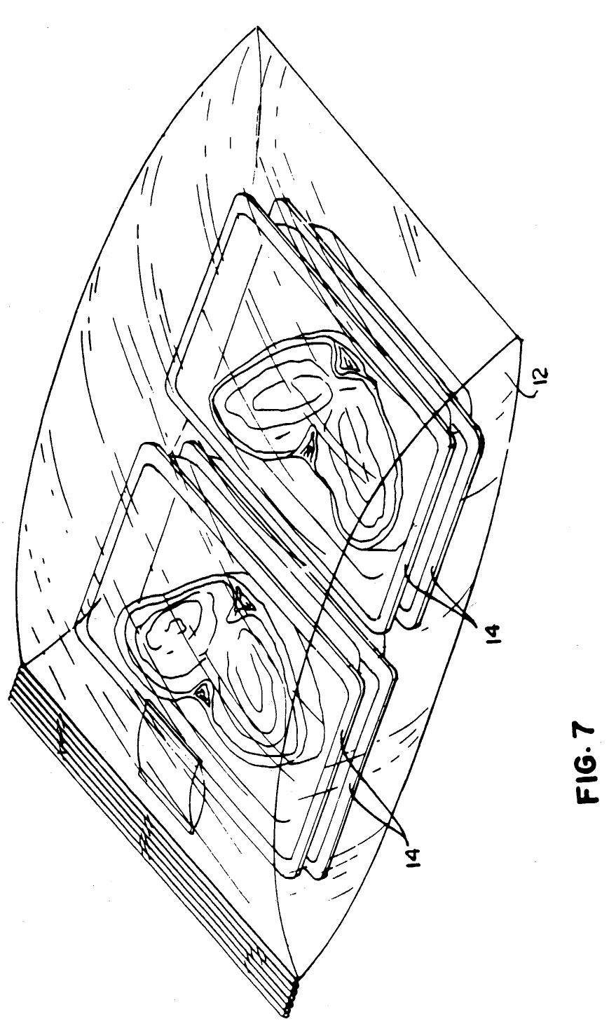

FIGS. 5 and 6a-d illustrate some details of the machine 60. The machine 60 includes an extendable snorkel-like probe 62, a movable seal clamp 64, a stationary seal bar housing 66, and an extendable heated seal bar 68 (FIGS. 6a-d). The probe 62 is disposed adjacent to the seal bar housing 66 and extends between the clamp 64 and the housing 66. The probe 62 is mounted to the machine 60 for movement between an extended position and a retracted position. The probe 62 is connected by piping 69 to both a conventional vacuum pump (not shown) and a gas tank (not shown). A conventional valve is used to select which of the two sources, the pump or the gas tank, is connected to the probe 62. The probe 62 may be open-faced or closed in the form of a tube or pipe. The seal clamp 64 includes a pair of rubber gaskets 70 and 72 and is pivotally movable between an open position spaced away from the seal bar housing 66 and a closed position alongside the seal bar housing 66. The seal bar 68 is situated within the seal bar housing 66 and is connected to an air cylinder 74 used to move the seal bar 68 between a retracted position and an extended sealing position. In its retracted position, the seal bar 68 is hidden within the seal bar housing 66 and is spaced away from the seal clamp 64. In its extended position, the seal bar 68 projects from the seal bar housing 66 applies pressure to the seal clamp 64.

The operation of the machine 60 is described below with reference to FIGS. 6a-d. As shown in FIG. 6a, the bag loading position requires the probe 62 to be in its retracted position, the seal clamp 64 to be in the open position, and the seal bar 66 to be in its retracted position. To load the package 12 on the machine 60, the package 12 is positioned such that an unsealed end of the package 12 is disposed between the open seal clamp 64 and the seal bar housing 66 and such that the retracted probe 62 extends into the package 12 via its unsealed end. Referring to FIG. 6b, using the handle 76 (FIG. 5), the seal clamp 64 is manually moved to its closed position such that the unsealed end of the package 12 is secured between the seal clamp 64 and the seal bar housing 66.

Referring to FIG. 6c, with the seal clamp 64 still closed, the probe 62 is moved to its extended position such that the probe 62 projects deeper into the package 12 via its unsealed end. The gasket 70 is interrupted at the location of the probe 62 to accommodate the probe 62 and, at the same time, prevents or inhibits air from the ambient environment from entering the package 12. After the probe 62 is moved to its extended position, the package 12 is subjected to evacuation and gas flushing cycles to reduce the oxygen level within the pocket 13 (FIG. 2) to no less than about 0.1 percent, which, as stated above, corresponds to an “equilibrium” oxygen level in the entire package 10 of no less than about one to two percent. The package 12 is first partially evacuated by connecting the probe 62 to the vacuum pump (not shown) and operating the vacuum pump. The machine 60 is preferably programmed to achieve a vacuum level of approximately 11 to 13 inches of mercury on the mercury scale. For the sake of comparison, a full vacuum corresponds to approximately 28 to 30 inches of mercury.

Once the package 12 reaches the programmed vacuum level, the machine 60 triggers a gas flushing cycle in which the probe 62 is connected to the gas tank (not shown) and a mixture of gases is introduced into the package 12. As discussed above, the gas mixture used in the present invention comprises from about 0.1 to about 0.8 vol. % carbon monoxide in a low oxygen environment. The gas mixture creates a modified atmosphere in the pocket 13 (FIG. 2) suitable for suppressing the growth of aerobic bacteria.

Referring to FIG. 6d, after subjecting the package 12 to evacuation and gas flushing cycles, the probe 62 is retracted and the air cylinder 74 is actuated to move the seal bar 68 to its extended position. The heated seal bar 68 presses the unsealed end of the package 12 against the rubber gasket 72 for an amount of time sufficient to thermally fuse the opposing films of the package 12 together and thereby seal the package 12. The seal bar 68 is then retracted into the seal bar housing 66 and the clamp 64 is opened to release the sealed package 12.

After the package 12 is sealed, the oxygen scavenger 28, if used, within the sealed package 12 continues to absorb any residual oxygen within the modified atmosphere package 10 until the oxygen level with the package 10 is reduced to approximately zero percent. In particular, the oxygen scavenger 28 absorbs (a) any residual oxygen remaining in the pocket 13 after the package 12 is subjected to the evacuation and gas flushing cycles applied by the machine 60 in FIGS. 5 and 6a-d; (b) any oxygen entering the pocket 13 from the inner package 14; and (c) any oxygen from the ambient environment that might permeate the package 12.

Activation of the oxygen scavenger 28 insures that the oxygen level is reduced to approximately zero percent at a rate sufficient to prevent or inhibit the formation of metmyoglobin, thereby preventing or inhibiting the discoloration of the raw meat within the inner package 14. As stated above, the pigment sensitive oxygen range in which the formation of metmyoglobin is accelerated is from about 0.05 percent to about two percent oxygen. Activation of the oxygen scavenger 28 allows the scavenger 28 to rapidly pass the oxygen level through this pigment sensitive range and then lower the oxygen level in the modified atmosphere package 10 to approximately zero percent in less than about 24 hours.

### EXAMPLES

Examples were prepared to illustrate some of the features of the present invention. Specifically, Comparative and Inventive Examples were prepared and tested to determine the initial product color, stability of color and relationship of color deterioration and microbial populations.

### Preparation of Examples

Specifically, Comparative Examples were prepared using an oxygen-permeable packaging under typical retail display conditions. Inventive Examples were prepared that utilized a gas blend of 0.4 vol. % carbon dioxide (CO), 30 vol. % carbon dioxide (CO₂) and 69.6 vol. % nitrogen (N₂) in the package atmosphere during storage conditions (pre-display). The Inventive Examples used an inner bag and an outer barrier bag. The outer bag was then removed and the products were displayed in the same manner as the Comparative Examples.

Various types of meats were tested including beef strip loins (strip steak), tenderloins, inside rounds and ground beef or chuck. Specifically, twelve beef strip loins (NAMP #180 containing the Longissimus muscle), 18 tenderloins (NAMP #189A containing the Psoas major muscle), 12 inside rounds (NAMP #169A containing the Semimembranosus muscle), and 6 batches of ground beef or chuck (80% lean) were obtained from a commercial source (Prairieland Processors, Inc., Kansas City, Kan.) at four to six days postmortem. Vacuum packaged subprimals and trim had an internal temperature of 34° F. and had never been frozen. Prior to product preparation, subprimals were stored at 34° F. This product was allocated to 6 replications (2 each of the strip loins and inside rounds and 3 tenderloins constituted a replication). The strip loins, tenderloins and inside rounds cut from the subprimals and separate batches of ground beef trim were randomly assigned to the replication and the treatment combinations.

One inch thick strip steaks cut from each subprimal and ground beef formed into about one-pound blocks (Beef Steaker, Model 600, Hobart Corp., Troy, Ohio) were placed on polystyrenic trays containing an absorbent pad (Ultra Zap Soakers, Paper Pak Products, La Verne, Calif.). The meat was overwrapped with a polyvinyl chloride (PVC) film (23,000 ccO₂/m²/24 hrs; Filmco MW4, LinPac, UK or Omnifilm 4P, Huntsman, Salt Lake City, Utah) using a mechanical wrapper (Filmizer Model CSW-3, Hobart Corporation, Troy Ohio) and was assigned randomly to either the Comparative Examples (using only the PVC-wrapped packages) or the Inventive Examples. The trays used in the Inventive Examples were placed individually in barrier bags (4.5 ccO₂/m²/24 hrs; NXE 1-300, Alec Enterprises, Burnsville, Minn.) along with an oxygen absorber (MRM-200, Multisorb Technologies, Buffalo, N.Y.) and the oxygen absorber was activated. The barrier bags of the Inventive Examples were evacuated and flushed with a certified gas blend containing 0.4 vol. % CO, 30 vol. % CO₂, and 69.6 vol. % N₂, and sealed (Freshvac Model A300, CVP Systems, Inc., Downers Grove, Ill.).

### Comparative Examples

Twelve packages of ground beef and one steak from each subprimal (12 strip loins, 12 inside rounds, 18 tenderloins, and the 6 batches of ground beef) were evaluated in the Comparative Examples to establish the color and microbial parameters for meat exposed only to atmospheric oxygen. These Comparative Examples were placed in display about 4 hours post-packaging.

### Inventive Examples

To test the effects of carbon monoxide (CO) in the Inventive Examples, one package of each product from each of 6 replications was selected at random for assignment to all possible combinations of two storage temperatures (35 and 43° F.) and three storage times (7,14, and 21 days for ground beef and 7, 21, and 35 days for the other meat product types). The lower temperature (35° F.) represented reasonably good industry practice, and the higher temperature (43° F.) represented a mildly abusive storage conditions. Prior to display, the oxygen and carbon dioxide levels in the outer barrier bags of the Inventive Examples were measured using a MOCON head space analyzer (PAC CHECK™ Model 650, MOCON/Modern Controls, Inc., Minneapolis, Minn.). At the end of storage of the MAP (Day 0 of the Display), the atmosphere of each Inventive Example was analyzed for O₂ and CO₂. Only 6 (each from a different treatment combination) of 288 packages were removed from the experiment due to leakage.

The Comparative and Inventive Examples were placed in a simulated retail display at 34±3° F. under 1614 lux (about 150 candles; Model 201, General Electric, Cleveland, Ohio) light intensity (Philips, 34 Watt, Ultralume 30) in open-top display cases (Unit Model DMF8, Tyler Refrigeration Corporation, Niles, Mich.). The display cases were programed to defrost two times per day at 12 hour intervals. The display case temperatures were monitored during display using temperature loggers (Omega Engineering, Inc., Stamford, Conn.). The display times varied based on product type, initial microbial loads and storage conditions. Each of the meat samples was removed from display when the color score was deemed unacceptable by a visual panel (a color score of ≧3.5).

Visual Color Testing

The color of the meat products was evaluated by ten individuals using a five-point scale where 1=very bright red, 2=bright red, 3=slightly dark red or tan, 4=moderately dark red or tan, and 5=extremely dark red or brown. The cut-off score for a consumer acceptable color was ≧3.5. Two portions of the inside rounds were scored separately (the outer ⅓ portion (OSM) and the deep, inner ⅓ portion (ISM)). Inside rounds typically are two-toned in color with the ISM being much less color stable compared to the OSM. The inner and outer portions were scored separately since one portion may have acceptable color, while the other has unacceptable color. These ten scores were averaged to produce the visual color ratings. When the examples reached a value of ≧3.5, they were removed from display.

Instrumental Color and Spectral Data

The Comparative and Inventive Examples were instrumentally analyzed for redness (a*), for Illuminant D-65 (daylight) using a HunterLab MiniScan Spectro photometer (1.25 inch diameter aperture, Hunter Associates Laboratory, Inc., Reston, Va.). Multiple readings (2 to 4 depending on cut size) were taken and averaged on each cut at each testing period. Normally, a* values (higher values indicate more redness) are highly correlated to visual appraisal. Visual scores were considered the “standard” with instrumental color being discussed relative to its agreement or disagreement with the visual panel, i.e., did the objective measurements confirm what the color panel saw.

Microbiological Procedures

Microbial populations were estimated at day 0 of display and at the end of display (day of unacceptable color). Day 0 of display was the end of the MAP storage for the Inventive Examples. For each post-display example, a portion of the surface area (top surface) that had been exposed to light was excised. After each package was opened aseptically, two cores (ca 2 in²) were removed (approximately ⅛ inch depth), placed in a sterile stomacher bag, and blended two minutes with 0.1% peptone diluent. Serial dilutions of the homogenate were prepared in 0.1% peptone and appropriate dilutions were plated in duplicate on Aerobic Plate Count PETRIFILM™ to determine total aerobic bacterial populations and on E. coli Count PETRIFILM™ to estimate generic E. Coli and total coliform bacterial counts. In addition, appropriate dilutions also were plated in duplicate on MRS agar to determine lactic acid bacterial (LAB) populations. Aerobic Plate Count PETRIFILM™ and E. coli Count PETRIFILM™ (3M Microbiology Products, St. Paul, Minn.) were incubated at 90° F. for 48 hours prior to enumeration. The lactic acid bacteria (LAB) populations were counted after 48 hours of 92° F. incubation in a CO₂ chamber. Microbial detection limits for intact muscle and ground beef were 1.76 count/cm² and 5.0 count/gram, respectively.

Sampling Times/Parameters Measured

The gas composition for oxygen and carbon dioxide levels of several Inventive Examples were tested on production day (2-3 hours post-packaging). The gas composition was also tested at the end of storage each temperature (35° F. and 43° F.). The initial counts for subprimals and ground beef were measured on the day of production, the end of modified atmosphere package (MAP) storage (Day 0 of Display) at two temperatures for the Inventive Examples, and at the end of display. The visual color was measured prior to display lighting, end of MAP storage (Day 0 of Display) at the two temperatures and after 60 to 90 min bloom at 34° F. The instrumental color was measured initially after packaging in PVC on production day for the Comparative Examples with minimal exposure to light. The instrument color was measured at the end of MAP storage at each of two temperatures and after 60 to 90 min bloom at 34° F. The instrument color was measured daily during display of the Inventive and Comparative Examples.

### Results and Discussion

Initial Product Color and Appearance

TABLE 1

| | Type Of | Comparative | | | |
|---|---|---|---|---|---|
| Test | Product | Examples | 7 | 14/21 | 21/35 |
| | | | Time¹ In Inventive | | |
| | | | Examples (Days At 35° F.) | | |
| Average Initial | GB | 1.3 | 1.6 | 1.7 | 1.8 |
| Visual Color | LD | 2.2 | 2.5 | 1.8 | 2.2 |
| At Day 0 | ISM | 1.8 | 2.0 | 1.7 | 2.0 |
| | OSM | 2.6 | 2.6 | 1.9 | 2.5 |
| | TL | 1.9 | 2.0 | 1.9 | 2.1 |
| Average Initial | GB | 23.4 | 25.6 | 25.9 | 25.6 |
| a* Values | LD | 25.8 | 25.7 | 27.1 | 28.1 |
| (redness) at | ISM | 28.5 | 26.9 | 30.0 | 29.4 |
| Day 0 | OSM | 27.4 | 27.7 | 29.8 | 29.5 |
| | TL | 23.6 | 27.5 | 30.0 | 29.3 |
| | | | Time¹ In Inventive | | |
| | | | Examples (Days At 43° F.) | | |
| Average Initial | GB | 1.3 | 1.7 | 1.8 | 2.5 |
| Visual Color | LD | 2.2 | 2.3 | 2.1 | 2.0 |
| At Day 0 | ISM | 1.8 | 1.8 | 1.7 | 2.4 |
| | OSM | 2.6 | 2.2 | 2.2 | 2.0 |
| | TL | 1.9 | 2.0 | 1.8 | 2.2 |
| Average Initial | GB | 23.4 | 25.7 | 25.1 | 25.5 |
| A* Values | LD | 25.8 | 25.5 | 28.7 | 27.5 |
| (redness) at | ISM | 28.5 | 28.7 | 28.6 | 27.5 |
| Day 0 | OSM | 27.4 | 27.7 | 30.2 | 29.4 |
| | TL | 23.6 | 27.8 | 28.7 | 26.4 |

¹GB was stored for 7, 14, and 21 days, while the other product types were stored for 7, 21, and 35 days.
GB = ground beef
LD = strip loins (stripsteak)
ISM = inner portion of inside round steaks
OSM = outer portion of inside round steaks
TL = tenderloin

TABLE 2

| | Type of | Comparative | | | |
|---|---|---|---|---|---|
| Test | Product | Examples | 7 | 14/21 | 21/35 |
| | | | Time¹ In Incentive | | |
| | | | Examples (Days At 35° F.) | | |
| Average Days in | GB | 3.6 | 3.0 | 3.0 | 2.3 |
| Display to | LD | 6.2 | 5.0 | 5.2 | 3.8 |
| Unacceptable | ISM | 3.2 | 4.8 | 4.0 | 3.5 |
| Color | OSM | 4.8 | 3.5 | 3.4 | 2.6 |
| | TL | 2.6 | 3.0 | 3.2 | 2.8 |
| | | | Time¹ In Inventive | | |
| | | | Examples (Days At 43° F.) | | |
| Average Days in | GB | 3.6 | 3.0 | 2.3 | 1.5 |
| Display to | LD | 6.2 | 5.0 | 3.3 | 2.3 |
| Unacceptable | ISM | 3.2 | 4.0 | 3.1 | 2.0 |
| Color | OSM | 4.5 | 3.0 | 2.4 | 1.6 |
| | TL | 2.6 | 2.0 | 2.3 | 1.7 |

¹GB was stored for 7, 14, and 21 days, while the other product types were stored for 7, 21, and 35 days.
GB = ground beef
LD = strip loins (stripsteak)
ISM = inner portion of inside round steaks
OSM = outer portion of inside round steaks
TL = tenderloin

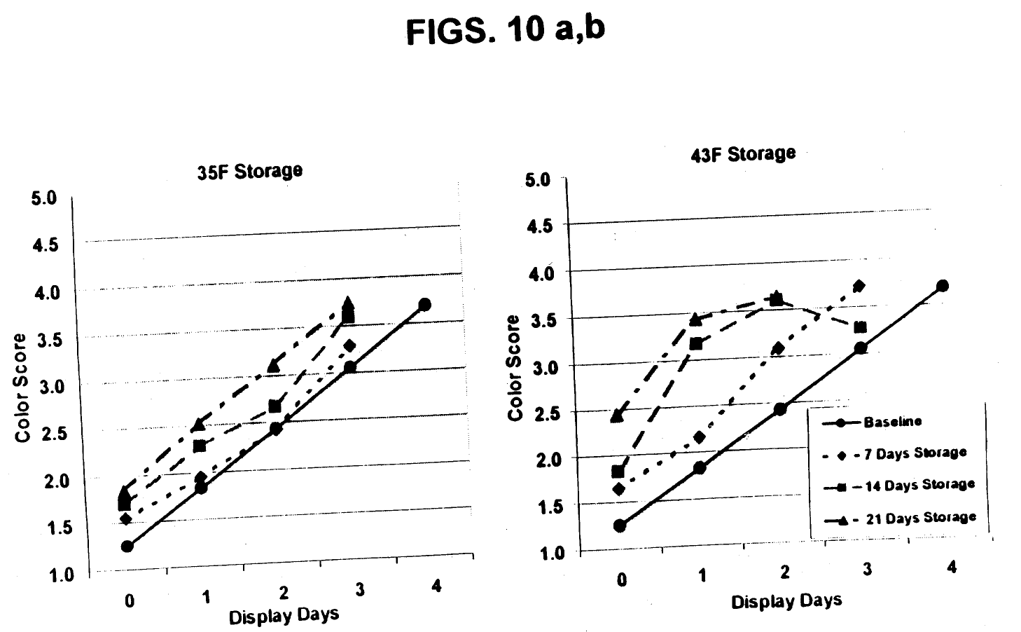

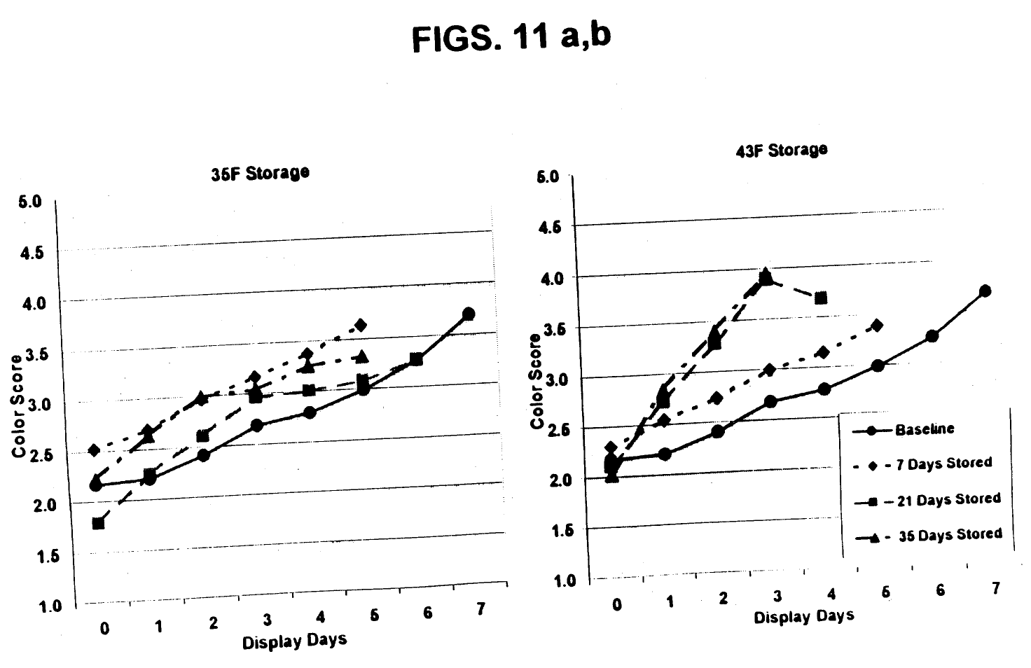

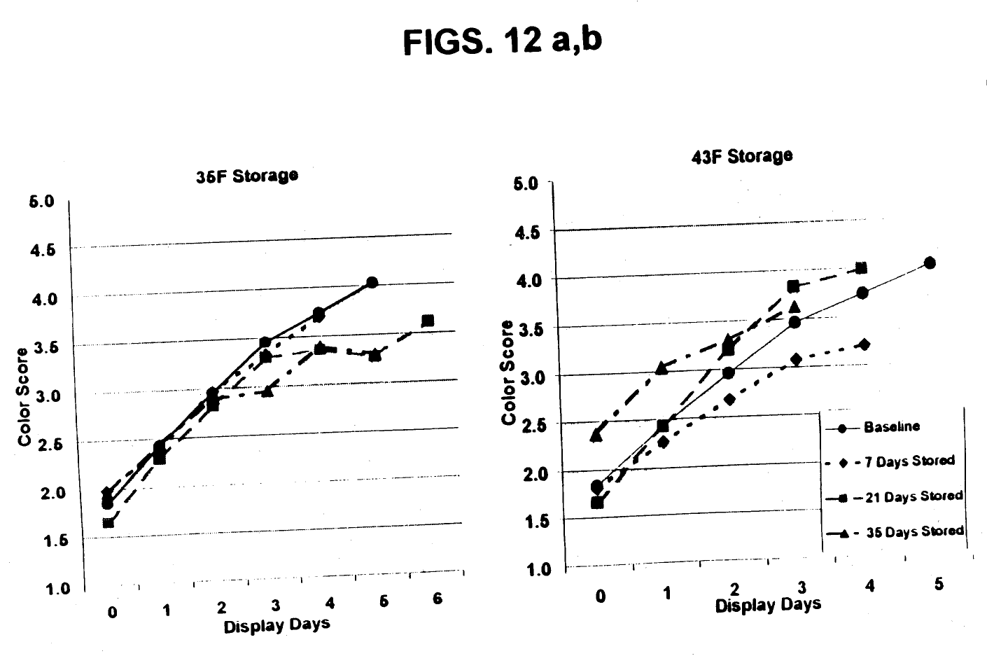

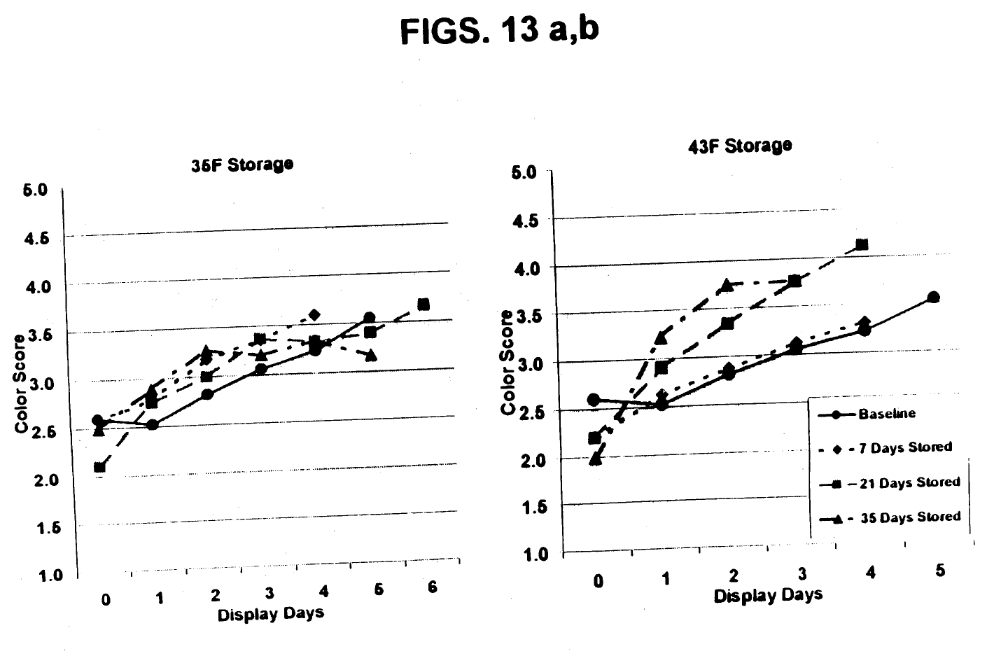

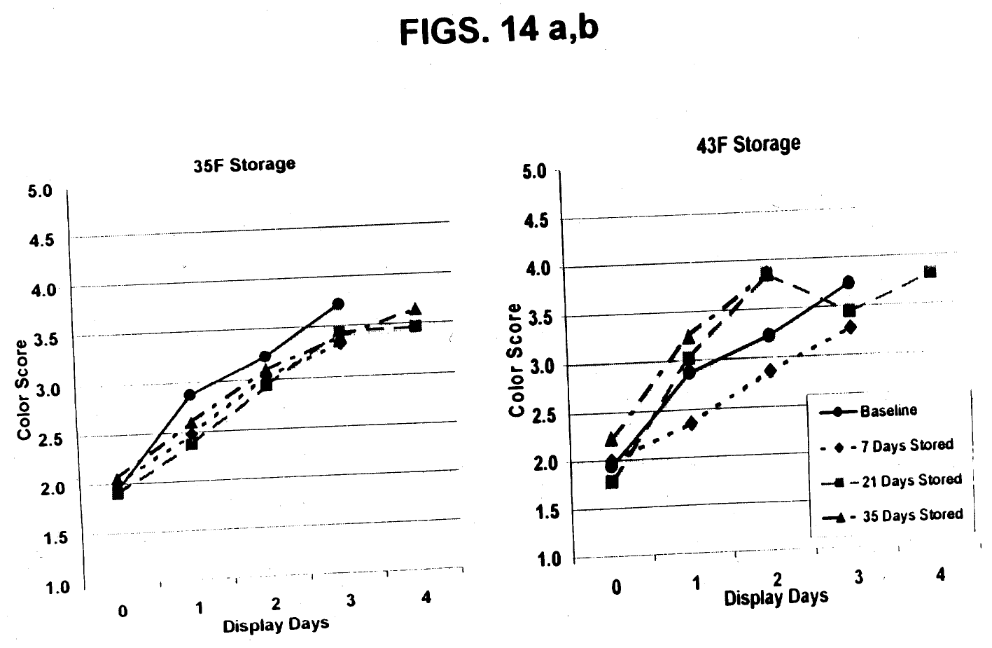

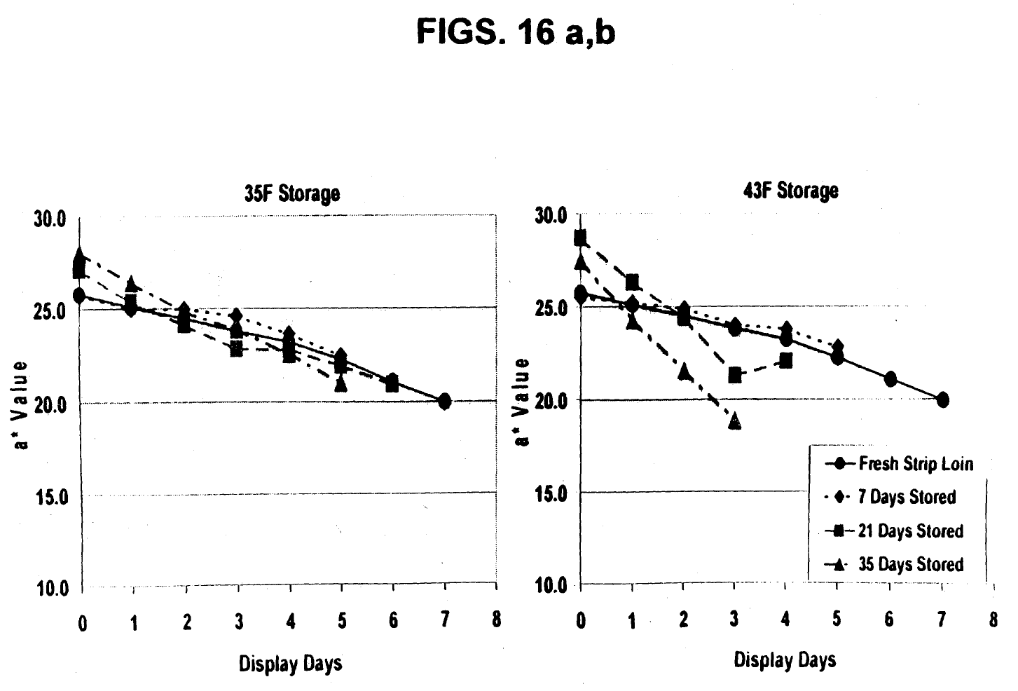

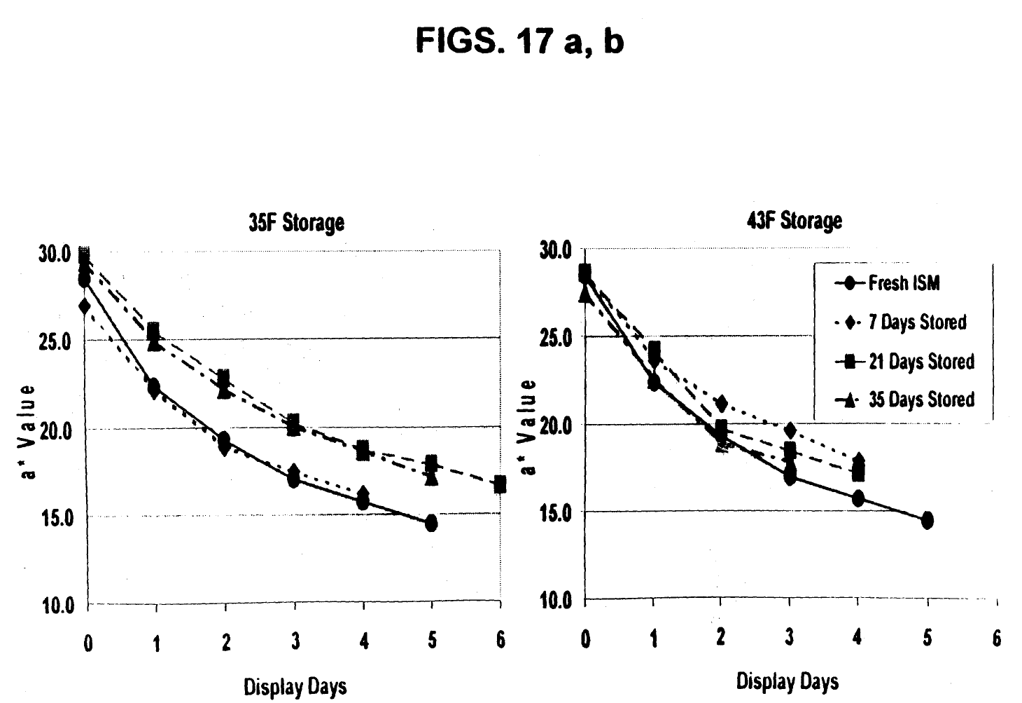

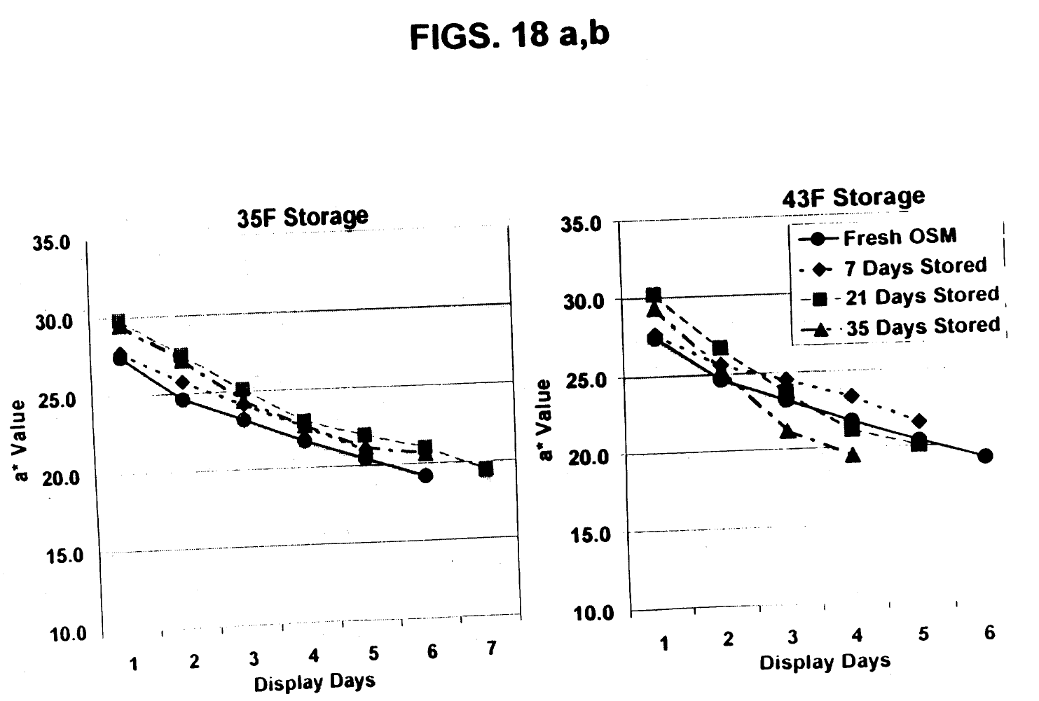

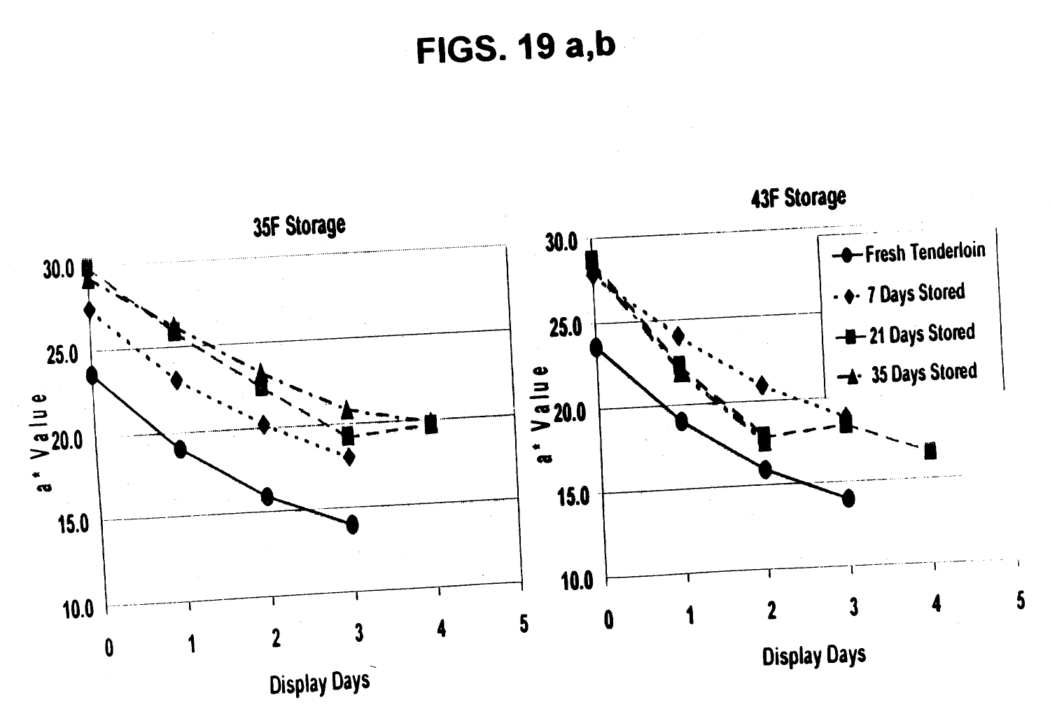

The color of the Inventive Examples of ground beef and steaks entering display (after MAP storage at 2 temperatures) was an attractive red color. Although there were several significant differences in visual scores and a* values (See Table 1 and FIGS. 10-19 at day 0) between the Inventive and Comparative Examples, the variation in color was generally within ±0.5 of a color score. In general, the initial color of products exposed to CO (Inventive Examples) was very similar to the color of meat products from the Comparative Examples (never exposed to CO). When differences occurred, they were more related to either storage temperature or postmortem age of the product.

Color Deterioration Profile

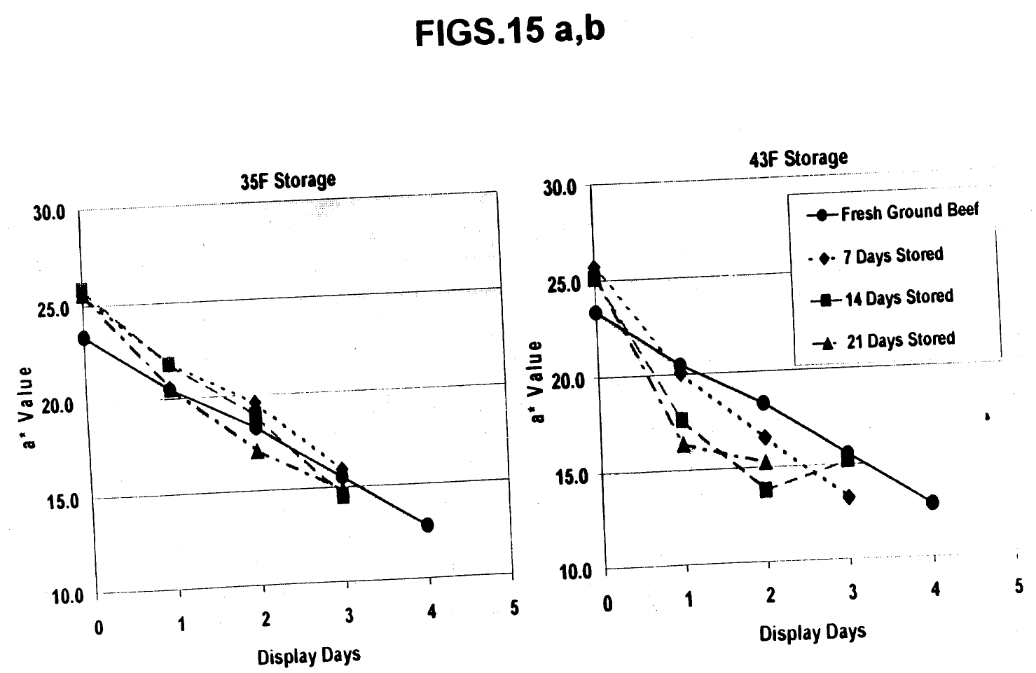

Visual panel scores (FIGS. 10-14) and instrumental color (a* values, FIGS. 15-19) showed that the Inventive Examples had color deterioration during display. As expected, visual scores increased (color deteriorated) and a* values decreased (loss of redness) as days in the display increased. In several instances, color appeared to improve late in the display as indicated by a decrease in visual scores (see, e.g., ground beef, strip loins and tenderloins at 43° F. in FIGS. 10, 11 and 14, respectively). These decreases in visual scores were not a return of redness. Rather, the apparent decrease resulted from removal of discolored packages from the preceding period, resulting in Inventive Examples with less overall discoloration remaining in the display.

In general, the color deterioration profiles followed an expected pattern. Namely, the freshest product (Comparative Examples) had the most stable, red color and the most days in display needed to reach borderline discoloration (See Tables 1 and 2) of all treatments. Exceptions occurred for the inner portion of the inside round and tenderloin products, where the Inventive Examples had a slightly more stable color than the Comparative Examples (See Table 2 comparing average number of days in display to unacceptable color). These two muscle areas are well known by retailers as having short color life. Thus, the Inventive Examples appeared to slightly improve color life when the inherent muscle chemistry desired for color was limited.

For the Inventive Examples, the longer the storage time, the faster the deterioration, especially at the higher storage temperature (See Tables 1 and 2). For Inventive Examples stored at 43° F., color deterioration was accelerated as compared to those stored at 35° F. Thus, effects of storage temperature (35° F. vs. 43° F.) and increased storage time (21 or 35 days) resulted in typical redness decline. Changes in a* values (FIGS. 15-19) followed the same pattern of color deterioration observed by the visual panelists. There was no evidence that color shelf life was unexpectedly lengthened by exposure of meat to carbon monoxide in the Inventive Examples.

Color Deterioration and Microbial Growth

TABLE 3

| | Type Of | Comparative | | | |
|---|---|---|---|---|---|
| Test | Product | Examples | 7 | 14/21 | 21/35 |
| | | | Time¹ In Inventive | | |
| | | | Examples (Days At 35° F.) | | |
| Day 0 in | GB | 2.7⁴ | 2.6 | 4.7 | 5.5 |
| Display² | LD | 0.7 | 0.2 | 1.4 | 1.7 |
| APCs³ Log | SM | 1.0 | 0.3 | 0.3 | 0.3 |
| 10 CFU | TL | 1.3 | 0.2 | 2.6 | 3.1 |
| End of | GB | 4.3⁵ | 4.4 | 5.6 | 5.5 |
| Display | LD | 1.4 | 0.4 | 2.9 | 3.4 |
| APCs,Log | SM | 0.6 | 0.1 | 0.6 | 2.0 |
| 10 CFU | TL | 0.3 | 1.3 | 3.5 | 3.4 |
| | | | Time¹ In Inventive | | |
| | | | Examples (Days At 43° F.) | | |
| Day 0 in | GB | 2.7 | 4.6 | 5.8 | 6.0 |
| Display² | LD | 0.7 | 1.3 | 3.2 | 5.1 |
| APCs³ Log | SM | 1.0 | 0.1 | >0.1 | 2.8 |
| 10 CFU | TL | 1.3 | 1.6 | 3.7 | 4.0 |
| End of | GB | 4.3 | 5.8 | 5.9 | 6.1 |
| Display | LD | 1.4 | 1.3 | 2.8 | 5.3 |
| APCs, Log | SM | 0.6 | 0.3 | 0.7 | 2.5 |
| 10 CFU | TL | 0.3 | 3.3 | 4.2 | 4.6 |

¹GB was stored for 7, 14, and 21 days, while the other product types were stored for 7, 21, and 35 days.
²Note:
In the Inventive Examples, this was the end of the MAP storage.
³APC = anerobic plate count
⁴2.7 = 2.7 × 10²
⁵4.3 = 4.3 × 10⁴
GB = ground beef
LD = strip loins (stripsteak)
SM = inside round steaks
TL = tenderloin

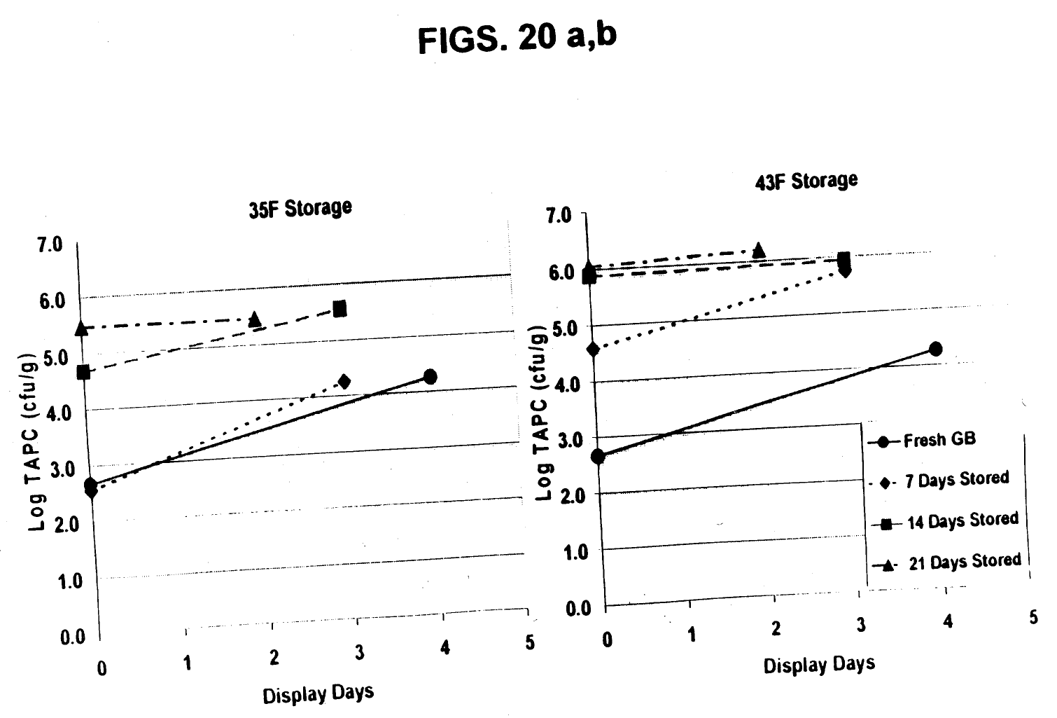

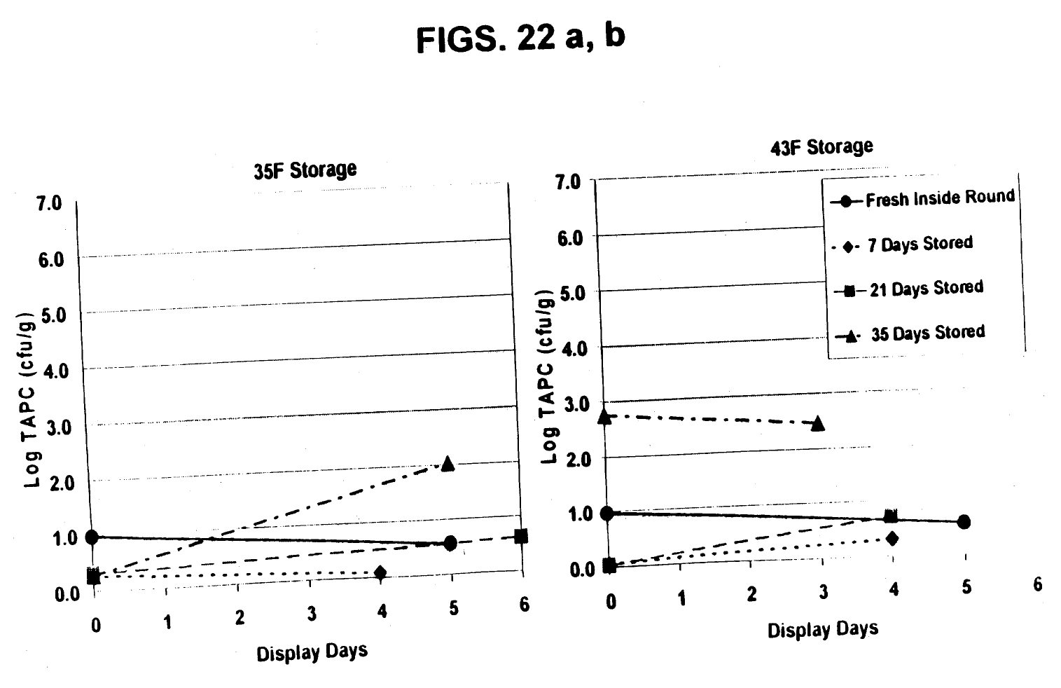

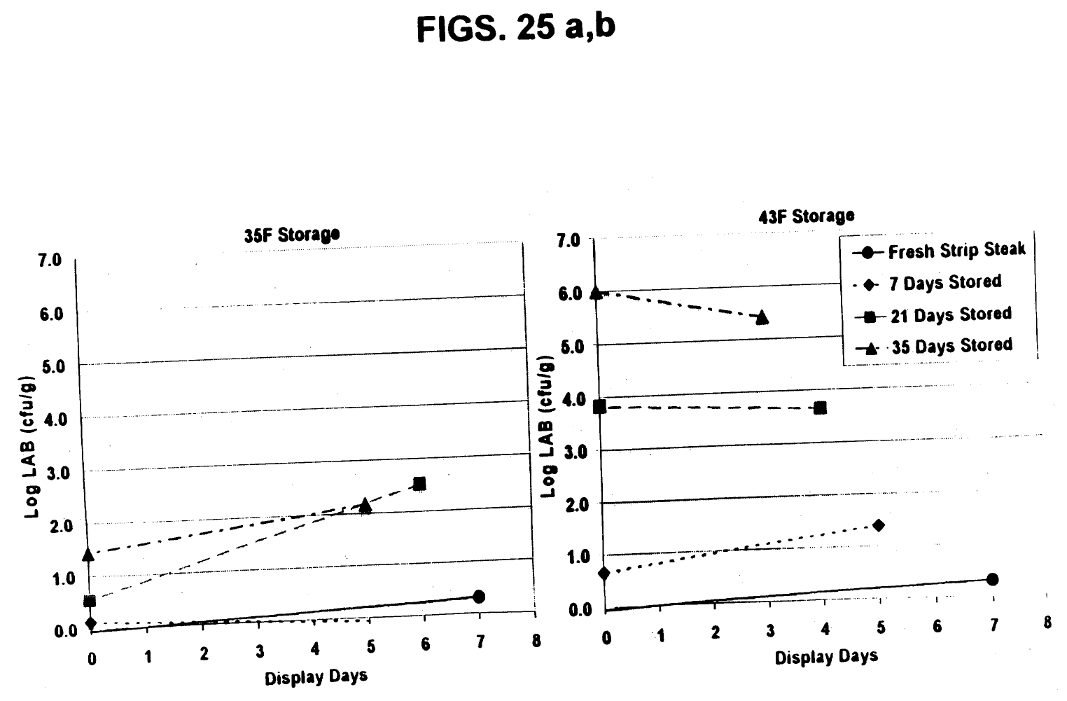

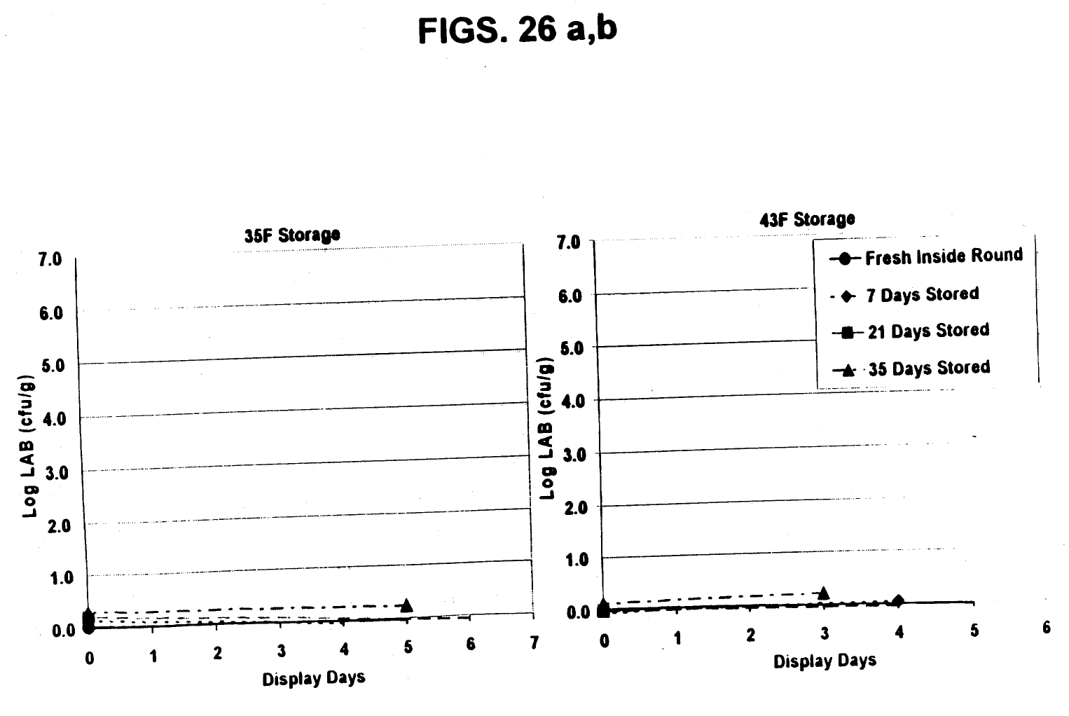

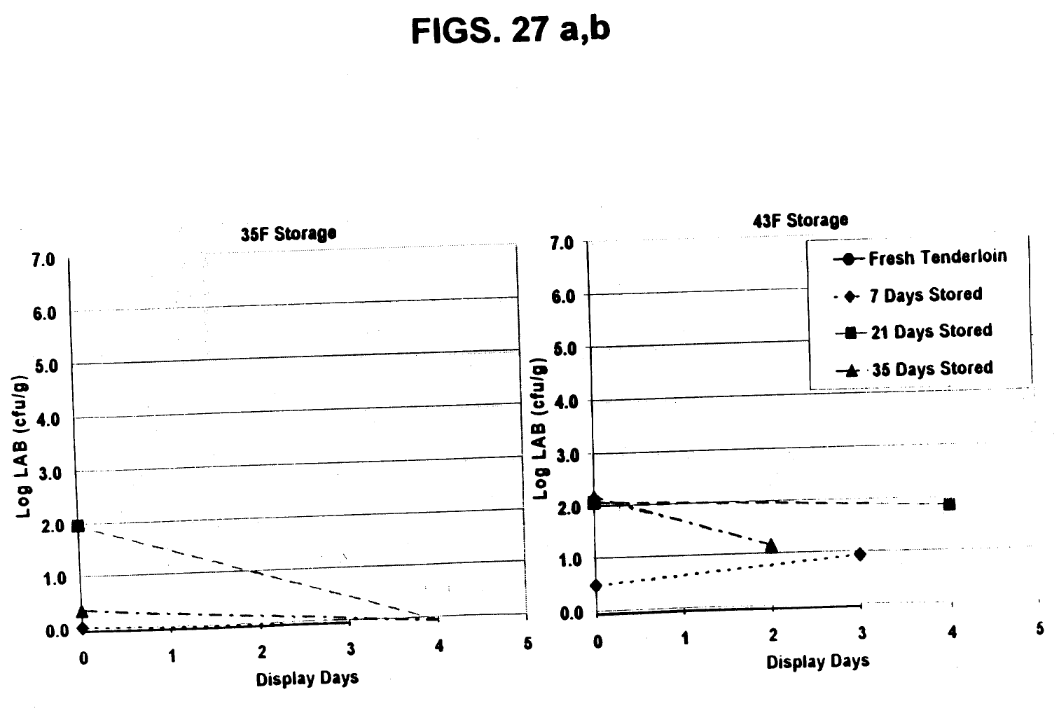

Comparative Examples: Initial, pre-display microbiological data of the Comparative Examples suggested that the raw materials were fresh and processed using good hygienic practices. For intact cuts, lactic acid bacteria, generic E. coli, and total coliform counts were below the detection limit of 1.76 CFU/in². Initial, pre-display aerobic plate counts (APC) of the Comparative Examples for intact muscles (i.e., not ground beef) ranged from 1 to 1.3 log₁₀ CFU/in². (See Table 3). Post-display counts were higher than pre-display APC of the Comparative Examples which was an increase in bacterial proliferation and typical deterioration. (See FIGS. 20-27). However, all tested samples of the Comparative Examples had sufficient microbes to be susceptible to spoilage.

The Comparative Examples were removed from display when the visual panel scores reached ≧3.5. However, the aerobic plate count (APC) of the Comparative Examples did not exceed 5 log₁₀ CFU/g as shown in FIGS. 20-23 and lactic acid bacteria (LAB) count did not exceed 2 log₁₀ CFU/g as shown in FIGS. 24-27. Thus, color life of the Comparative Examples did not exceed microbial soundness.

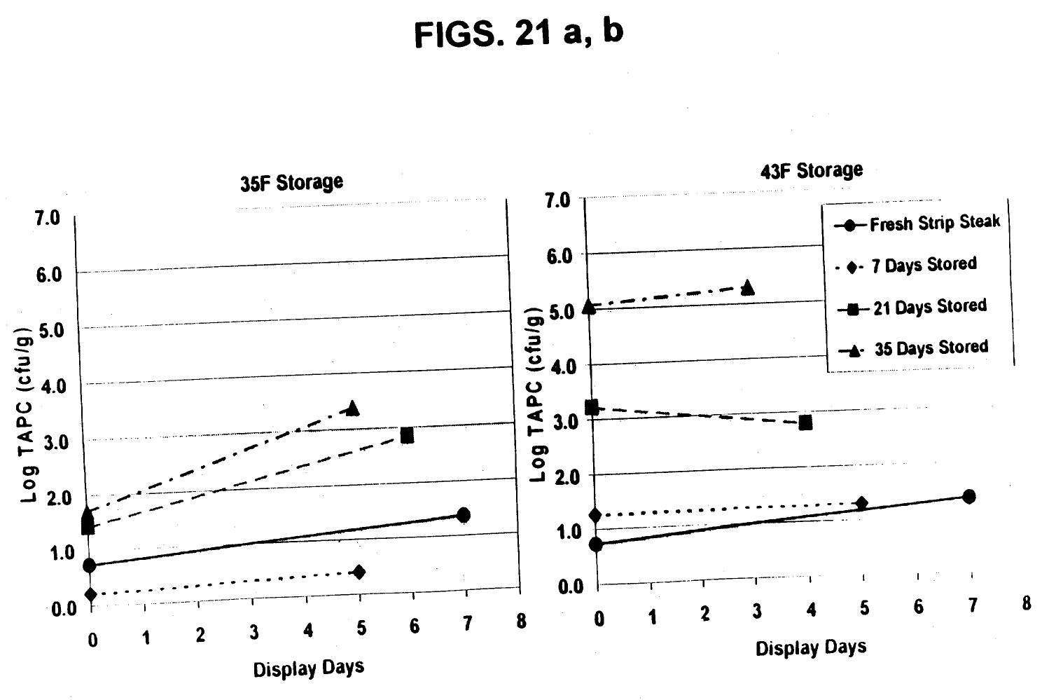

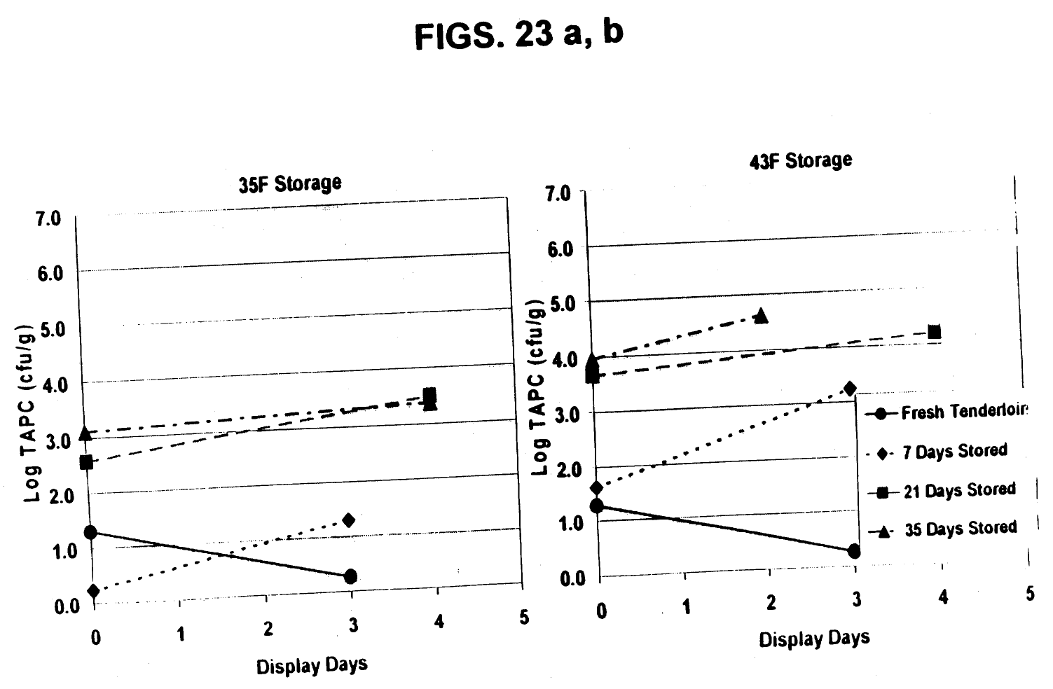

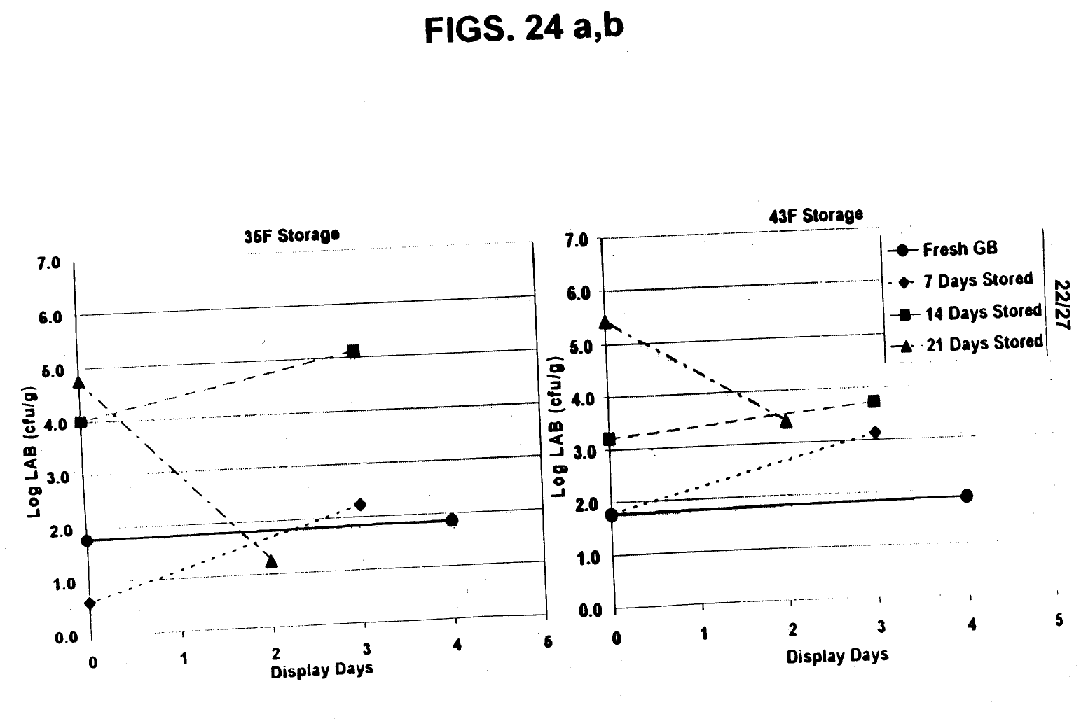

Inventive Examples: The microbial growth of the Inventive Examples were similar to the Comparative Examples. (See Table 3 and FIGS. 20-27). The Inventive Examples at a slightly abusive temperature (43° F.) showed a more rapid increase in microbial counts compared to Inventive Examples stored at 35° F. At Day 0 of display and post-display of the Inventive Examples, the APC's were almost always higher at 43° F. than 35° F. (See Table 3), and during the later days of storage at the higher temperature, the differences were more obvious. Significant changes occurred in all meat cuts and ground beef with the exception of the inside rounds. Counts for the inside rounds were lower than expected and no significant changes occurred until day 35 of the Inventive Examples. This suggests that quality products that have been handled in a sanitary fashion can be stored in the Inventive System up to 35 days without comprising microbial quality. The APCs for intact strip loins and tenderloin steaks stored at 35° F. were lower on all days of display on days 21 and 35 post-MAP than steaks stored at 43° F. (See FIGS. 21 and 23). Although products did not show a difference in APCs 7 days post-MAP, those products stored at the higher temperature (43° F.) were more inferior 21 and 35 days post-MAP.

The Inventive Examples were also removed from display when the visual panel scores reached a score ≧3.5. The aerobic plate count (APC) of the Inventive Examples did not exceed about 6 log₁₀ (CFU/g as shown in FIGS. 20-23 and the lactic acid bacteria (LAB) counts did not exceed 6 log₁₀ (CFU/g as shown in FIGS. 24-27. Bacteria growth was neither encouraged nor suppressed by the Inventive Examples as compared to the Comparative Examples. Color life of the Inventive Examples did not exceed microbial soundness.

As discussed above, visual color scoring was considered as the “standard” for determining the time to remove products from display. Because the visual panel scores were the deciding factor for length of shelf life, the interdependence between visual color and aerobic plate counts (APC) and lactic acid bacteria (LAB) were considered quite important.

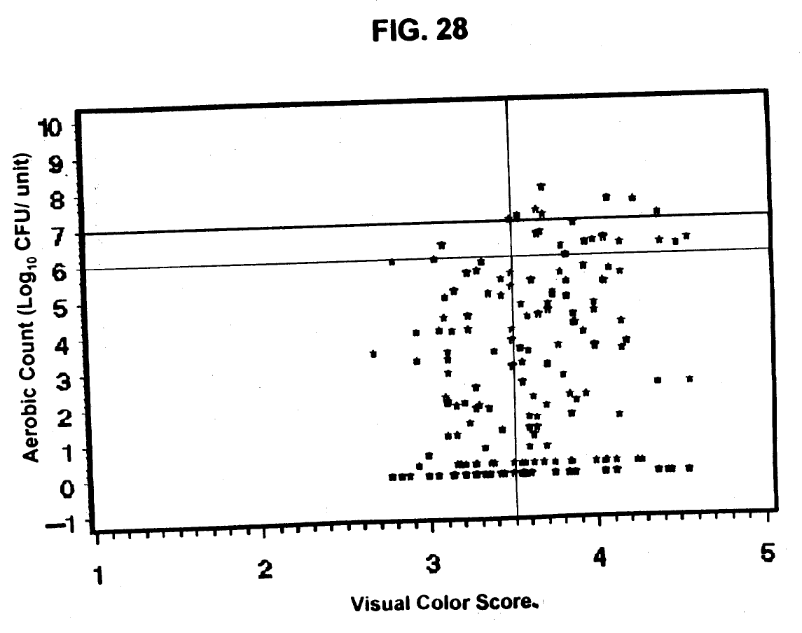

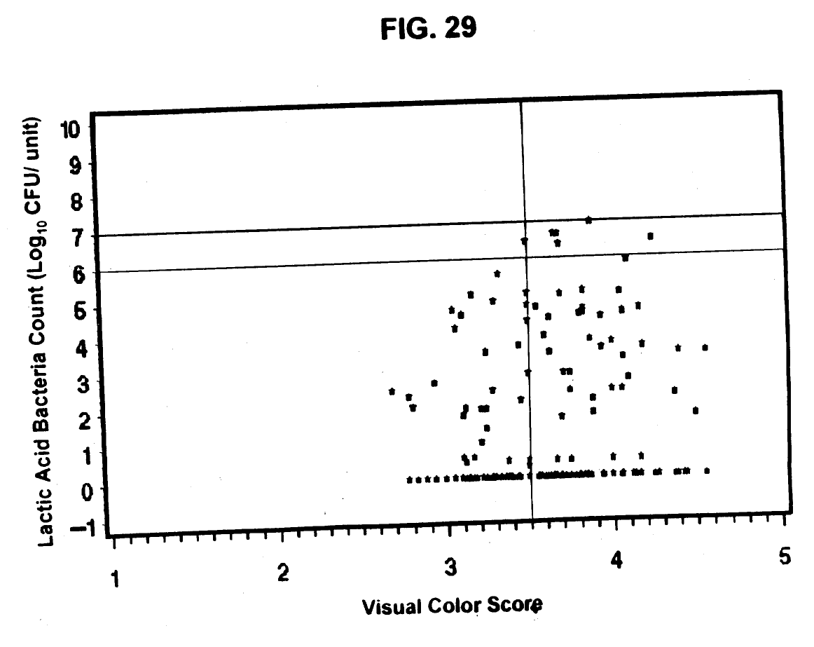

FIGS. 28-29 show aerobic and lactic acid bacterial growth at the end of display plotted against their corresponding visual color scores. All data observations from both the Inventive and Comparative Examples were summed over storage temperature, storage time, and product type and plotted in one graph. If color masked spoilage, then there should be multiple points in the upper left quadrant of the plot, the area represented by unacceptable microbial counts but with acceptable color (i.e., scores <3.5). This did not occur with any frequency in either FIG. 28 or 29. Thus, it does not appear that exposure of meat to carbon monoxide in the Inventive Examples during extended storage (up to 35 days at either 35° F. or 43° F.) caused meat color to hide spoilage.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method of manufacturing a modified atmosphere package, comprising:
supplying a first package including a non-barrier portion substantially permeable to oxygen;
placing a retail cut of raw meat within the first package;
sealing the first package;
supplying a second package substantially impermeable to oxygen;
covering the first package with the second package without sealing the second package so as to create a pocket between the first and second packages;
supplying a mixture of gases into the pocket, the gas mixture comprising from about 0.1 to about 0.8 vol. % carbon monoxide and at least one other gas to form a low oxygen, environment so as to form carboxymyoglobin on a surface of the raw meat;
removing oxygen from the pocket so as to sufficiently reduce an oxygen level therein so as to inhibit or prevent the formation of metmyoglobin on the surface of the raw meat; and
sealing the second package.

2. The method of claim 1 further including supplying an oxygen scavenger.

3. The method of claim 1 further including supplying an oxygen scavenger, activating the oxygen scavenger with an oxygen scavenger accelerator, and positioning the oxygen scavenger external to the first package such that the oxygen scavenger is capable of absorbing oxygen within the pocket, the activated oxygen scavenger aggressively absorbing any residual oxygen in the modified atmosphere package.

4. The method of claim 3, wherein the activated oxygen scavenger reduces the oxygen level within the modified atmosphere package to approximately zero percent in less than about 24 hours.

5. The method of claim 1, wherein the oxygen level of the pocket is less than 1,000 ppm.

6. The method of claim 5, wherein the oxygen level of the pocket is less than about 500 ppm.

7. The method of claim 1, wherein the step of removing oxygen from the pocket includes evacuating the pocket.

8. The method of claim 1, wherein the step of removing oxygen from the pocket includes flushing the pocket with the gas mixture.

9. The method of claim 1, wherein the gas mixture further comprises nitrogen, carbon dioxide or the combination thereof.

10. The method of claim 1, wherein the gas mixture further consists essentially of nitrogen, carbon dioxide or the combination thereof.

11. The method of claim 1, wherein the gas mixture consists essentially of from about 0.1 to about 0.8 vol. % carbon monoxide, from about 40 to about 80 vol. % nitrogen and from about 20 to about 60 vol. % carbon dioxide.

12. The method of claim 1, wherein the gas mixture consists of from about 0.1 to about 0.8 vol. % carbon monoxide with the remainder carbon dioxide.

13. The method of claim 1 further including removing the second package from the first package before retailing.

14. The method of claim 1 further including removing the second package from the first package so as to allow the raw meat to be exposed to ambient atmosphere, the raw meat having color degradation similar to a fresh cut of the same raw meat.

15. The method of claim 1, wherein the second package is adapted to be removable from at least a portion of the first package without destroying the first package.

16. The method of claim 1 further including placing the retail cut of raw meat on a foam tray.

17. The method of claim 1, wherein the non-barrier portion comprises a polyolefin or a polyvinyl chloride overwrap.

18. The method of claim 1, wherein the gas mixture is supplied to the pocket such that the oxymyoglobin substantially converts directly to carboxymyoglobin.

19. The method of claim 1, wherein the oxymyoglobin substantially converts to deoxymyoglobin before the gas mixture is supplied to the pocket so as to convert deoxymyoglobin directly to carboxymyoglobin.

20. The method of claim 1, wherein the gas mixture comprises from about 0.3 to about 0.5 vol. % carbon monoxide.

21. The method of claim 1, wherein the gas mixture comprises from about 0.1 to about 0.5 vol. % carbon monoxide.

22. A method of manufacturing a modified atmosphere package, comprising:
supplying a first package including a non-barrier portion substantially permeable to oxygen;
placing a retail cut of raw meat within the first package;
sealing the first package;
supplying a second package substantially impermeable to oxygen;
covering the first package with the second package without sealing the second package so as to create a pocket between the first and second packages;
supplying a mixture of gases into the pocket, the gas mixture comprising from about 0.1 to about 0.8 vol. % carbon monoxide and at least one other gas to form a low oxygen environment, the gas mixture being supplied so as to substantially convert the oxymyoglobin directly to carboxymyoglobin on a surface of the raw meat;
removing oxygen from the pocket so as to reduce an oxygen level sufficiently therein so as to inhibit or prevent the formation of metmyoglobin on the surface of the raw meat; and
sealing the second package.

23. The method of claim 22 further including supplying an oxygen scavenger.

24. The method of claim 22 further including supplying an oxygen scavenger, activating the oxygen scavenger with an oxygen scavenger accelerator, and positioning the oxygen scavenger external to the first package such that the oxygen scavenger is capable of absorbing oxygen within the pocket, the activated oxygen scavenger aggressively absorbing any residual oxygen in the modified atmosphere package.

25. The method of claim 22, wherein the oxygen level of the pocket is less than 1,000 ppm.

26. The method of claim 25, wherein the oxygen level of the pocket is less than about 500 ppm.

27. The method of claim 22, wherein the step of removing oxygen from the pocket includes evacuating the pocket.

28. The method of claim 22, wherein the step of removing oxygen from the pocket includes flushing the pocket with the gas mixture.

29. The method of claim 22, wherein the gas mixture further comprises nitrogen, carbon dioxide or the combination thereof.

30. The method of claim 22, wherein the gas mixture consists essentially of from about 0.1 to about 0.8 vol. % carbon monoxide, from about 40 to about 80 vol. % nitrogen and from about 20 to about 60 vol. % carbon dioxide.

31. The method of claim 22, wherein the gas mixture consists of from about 0.1 to about 0.8 vol. % carbon monoxide with the remainder carbon dioxide.

32. The method of claim 22 further including removing the second package from the first package before retailing.

33. The method of claim 22 further including removing the second package from the first package so as to allow the raw meat to be exposed to ambient atmosphere, the raw meat having color degradation similar to a fresh cut of the same raw meat.

34. The method of claim 22, wherein the second package is adapted to be removable from at least a portion of the first package without destroying the first package.

35. The method of claim 22 further including placing the retail cut of raw meat on a foam tray and the non-barrier portion comprises a polyolefin or a polyvinyl chloride overwrap.

36. The method of claim 22, wherein the gas mixture comprises from about 0.3 to about 0.5 vol. % carbon monoxide.

37. The method of claim 22, wherein the gas mixture comprises from about 0.1 to about 0.5 vol. % carbon monoxide.

38. A method of manufacturing a modified atmosphere package, comprising:
supplying a package, a first layer having at least a portion being substantially permeable to oxygen and a second layer being substantially impermeable to oxygen;
placing a retail cut of raw meat within the package;
supplying a mixture of gases within the package, the gas mixture comprising from about 0.1 to about 0.8 vol. % carbon monoxide and at least one other gas to form a low oxygen environment so as to form carboxymyoglobin on a surface of the raw meat;
removing oxygen within the package so as to sufficiently reduce an oxygen level therein so as to inhibit or prevent the formation of metmyoglobin on the surface of the raw meat;
sealing the first layer to the package; and
sealing the second layer to at least one of the package and the first layer.

39. The method of claim 38, wherein a pocket is formed between the first layer and the second layer.

40. The method of claim 38, wherein the second layer is at least sealed to the first layer and the second layer is adapted to be peelable from the first layer.

41. The method of claim 38, wherein the package includes a bottom wall, a continuous side wall, and a continuous rim, the continuous side wall encompassing the bottom wall and extending upwardly and outwardly from the bottom wall, the continuous rim encompassing an upper edge of the continuous side wall and projecting generally laterally outwardly therefrom.

42. The method of claim 38 further including the step of removing the second layer.

43. The method of claim 38 further including supplying an oxygen scavenger.

44. The method of claim 38, wherein the oxygen level in the package is less than 1,000 ppm.

45. The method of claim 38, wherein the oxygen level in the package is less than about 500 ppm.

46. The method of claim 38, wherein the step of removing oxygen from the package includes evacuating the package.

47. The method of claim 38, wherein the step of removing oxygen from the package includes flushing the package with the gas mixture.

48. The method of claim 38, wherein the gas mixture further comprises nitrogen, carbon dioxide or the combination thereof.

49. The method of claim 38, wherein the gas mixture consists essentially of from about 0.1 to about 0.8 vol. % carbon monoxide, from about 40 to about 80 vol. % nitrogen and from about 20 to about 60 vol. % carbon dioxide.

50. The method of claim 38, wherein the gas mixture consists of from about 0.1 vol. % to about 0.6 vol. % carbon monoxide with the remainder carbon dioxide.

51. The method of claim 38 further including placing the retail cut of raw meat on a foam tray.

52. The method of claim 38, wherein the non-barrier portion comprises a polyolefin or a polyvinyl chloride overwrap.

53. The method of claim 38, wherein the gas mixture is supplied to the package such that the oxymyoglobin substantially converts directly to carboxymyoglobin.

54. The method of claim 38, wherein the oxymyoglobin substantially converts to deoxymyoglobin before the gas mixture is supplied to the package so as to convert deoxymyoglobin directly to carboxymyoglobin.

55. The method of claim 38, wherein the gas mixture comprises from about 0.3 to about 0.5 vol. % carbon monoxide.

56. The method of claim 38, wherein the gas mixture comprises from about 0.1 to about 0.5 vol. % carbon monoxide.

57. A modified atmosphere package, comprising:
a first package comprising a non-barrier portion substantially permeable to oxygen, the first package being configured and sized to fully enclose a retail cut of raw meat; and
a second package being substantially impermeable to oxygen, the second package adapted to cover the first package so as to create a pocket between the first and second packages, the pocket having a mixture of gases comprising from about 0.1 to about 0.8 vol. % carbon monoxide and at least one other gas to form a low oxygen environment so as to form carboxymyoglobin on a surface of the raw meat.

58. The package of claim 57 further including an oxygen scavenger.

59. The package of claim 57 further including an activated oxygen scavenger.

60. The package of claim 57, wherein the first package is shaped differently than the second package.

61. The package of claim 57, wherein the first package includes a tray.

62. The package of claim 61, wherein the tray is comprised of polystyrene foam.

63. The package of claim 62, wherein the tray includes a bottom wall, a continuous side wall, and a continuous rim, the continuous side wall encompassing the bottom wall and extending upwardly and outwardly from the bottom wall, the continuous rim encompassing an upper edge of the continuous side wall and projecting generally laterally outwardly therefrom.

64. The package of claim 57, wherein the non-barrier portion is a stretch film.

65. The package of claim 64, wherein the stretch film comprises a polyolefin or polyvinyl chloride.

66. The package of claim 57, wherein the first package is substantially free of oxygen therein in response to the first package being flushed with the one or more gases.

67. The package of claim 57, wherein the second package is a polymeric bag.

68. The package of claim 57, wherein the gas mixture comprises from about 0.3 to about 0.5 vol. % carbon monoxide.

69. The package of claim 57, wherein the gas mixture comprises from about 0.1 to about 0.5 vol. % carbon monoxide.

70. A modified atmosphere package comprising first and second compartments separated by a partition member, the partition member including a non-barrier portion substantially permeable to oxygen, the first and second compartments being encompassed by an outer wall substantially impermeable to oxygen, the second compartment being configured and sized to fully enclose a retail cut of raw meat, and the first compartment containing a mixture of gases, the gas mixture comprising from about 0.1 to about 0.8 vol. % carbon monoxide and at least one other gas to form a low oxygen environment so as to form carboxymyoglobin on a surface of the meat.

71. The package of claim 70 further including an oxygen scavenger.

72. The package of claim 70, wherein the second compartment package includes a tray.

73. The package of claim 72, wherein the tray is comprised of polystyrene foam.

74. The package of claim 70, wherein the gas mixture comprises from about 0.3 vol. % to about 0.5 vol. % carbon monoxide.

75. The package of claim 70, wherein the gas mixture comprises from about 0.1 vol. % to about 0.5 vol. % carbon monoxide.

76. A modified atmosphere package, comprising:
a package being configured and sized to fully enclose a retail cut of raw meat, the package having a mixture of gases comprising from about 0.1 to about 0.8 vol. % carbon monoxide and at least one other gas to form a low oxygen environment so as to form carboxymyoglobin on a surface of the raw meat;
a first layer having at least a portion being substantially permeable to oxygen and sealed to the package; and
a second layer being substantially impermeable to oxygen and sealed to at least one of the package and the first layer.

77. The package of claim 76, wherein a pocket is formed between the first layer and the second layer.

78. The package of claim 76, wherein the second layer is at least sealed to the first layer and the second layer is adapted to be peelable from the first layer.

79. The package of claim 76, wherein the package includes a bottom wall, a continuous side wall, and a continuous rim, the continuous side wall encompassing the bottom wall and extending upwardly and outwardly from the bottom wall, the continuous rim encompassing an upper edge of the continuous side wall and projecting laterally outwardly therefrom.

80. The package of claim 76 further including supplying an oxygen scavenger.

81. The package of claim 76, wherein the oxygen level in the package is less than 1,000 ppm.

82. The package of claim 81, wherein the oxygen level in the package is less than about 500 ppm.

83. The package of claim 76, wherein the gas mixture consists essentially of from about 0.1 to about 0.8 vol. % carbon monoxide, from about 40 to about 80 vol. % nitrogen and from about 20 to about 60 vol. % carbon dioxide.

84. The package of claim 77, wherein the package further includes a foam tray sized to hold the meat.

85. The package of claim 77, wherein the gas mixture comprises from about 0.3 to about 0.5 vol. % carbon monoxide.

86. The package of claim 77, wherein the gas mixture comprises from about 0.1 to about 0.5 vol. % carbon monoxide.
